(19) United States
(12) Patent Application Publication
(10) Pub. No.: US 2023/0393962 A1
(43) Pub. Date: Dec. 7, 2023

(54) AUTOMATIC DIAGNOSTICS AND MITIGATION FOR IMPROVING APPLICATION RESPONSIVENESS

(71) Applicant: Apple Inc., Cupertino, CA (US)

(72) Inventors: Sonia Mannan, San Jose, CA (US); Anshul Dawra, Campbell, CA (US); John T. Crowson, San Diego, CA (US); Akshay Salpekar, Dublin, CA (US); Phillip J. Azar, Oakland, CA (US); Anthony R. Newnam, San Francisco, CA (US)

(73) Assignee: Apple Inc., Cupertino, CA (US)

(21) Appl. No.: 18/204,784

(22) Filed: Jun. 1, 2023

Related U.S. Application Data
(60) Provisional application No. 63/348,972, filed on Jun. 3, 2022.

(51) Int. Cl. G06F 11/34; G06F 11/32

(52) U.S. Cl. CPC G06F 11/3476; G06F 11/324

(57) ABSTRACT

Embodiments of the present disclosure present devices, methods, and computer readable medium related to identifying, generating, and presenting diagnostic data corresponding to devices from which the diagnostic data was obtained. In some embodiments, the diagnostic data may include log file data associated with a common error, operational metrics, or the like. Commonality may be identified based on call path signatures. Call path signatures may be generated for log files and compared to one another to determine matches. Matched log files may be grouped or otherwise associated with a common error (e.g., a hanging error). A user interface is provided to view the diagnostic data associated with a common error. The disclosed techniques provide an intelligent method for visualizing performance changes and/or identifying errors in applications.

### CROSS-REFERENCES TO RELATED APPLICATIONS

This application is claims priority under 35 U.S.C. § 119(e) to U.S. Provisional Application No. 63/348,972, filed on Jun. 3, 2022, entitled “AUTOMATIC DIAGNOSTICS AND MITIGATION FOR IMPROVING APPLICATION RESPONSIVENESS,” the contents of which is herein incorporated by reference.

### FIELD

The present disclosure relates generally to techniques for monitoring third-party applications for processing delays and managing call stack information related to those delays from various electronic devices executing those third-party applications.

### BACKGROUND

Device users can be concerned with the performance of the third-party applications operating on their devices. Identifying the performance of a given application can be difficult for third-party developers who do not possess in-depth knowledge of the operating system and how to access such data. Often, third-party developers do not understand what specific data to gather to improve performance of the application. Without helpful data, errors and enhancements can be overlooked, leading to suboptimal application performance. When the third-party application is complex, the amount of data applicable to a given error can be overwhelming. Requiring developers to sift through large amounts of data to diagnose errors (e.g., hanging issues) or identify potential enhancements can slow implementation time and perpetuate performance issues.

### BRIEF SUMMARY

Certain embodiments are directed to techniques (e.g., a method, a memory or non-transitory computer readable medium storing code or instructions executable by one or more processors) for managing diagnostic data, including providing this information through an application programming interface (API) for developers to access for optimizing their applications. An objective of the disclosed techniques is to monitor for processing delays and surface diagnostic data related to those delays in a way that has little to no impact on performance of the application, the operating system, and the electronic device. Another objective is to distill large amounts of diagnostic data corresponding to any suitable number of electronic devices and/or third-party applications to an amount and format that is simple for the developer to synthesize and search. The diagnostic data can be obtained from different parts of the operating system, some in the kernel space, and some in the user space. The diagnostic data can be collected for multiple devices running the application and aggregated for developer review in an integrated development environment.

These and other embodiments of the invention are described in detail below. For example, other embodiments are directed to systems, devices, and computer readable media associated with methods described herein.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

FIG. 1 illustrates a simplified, exemplary diagram of a system 100 for obtaining, aggregating, processing, and visualizing diagnostic data for evaluating and/or debugging errors in third-party application 102, in accordance with at least one embodiment.

FIG. 2 illustrates an exemplary diagram of a system for collecting, aggregating, and visualizing diagnostic data corresponding to one or more third-party applications, in accordance with at least one embodiment.

FIG. 3 is a flowchart illustrating an example method for ingesting and processing data, in accordance with at least one embodiment.

FIG. 4 is a block diagram illustrating an exemplary aggregation server, in accordance with at least one embodiment.

FIG. 5 is a block diagram illustrating an exemplary method for generating call path signatures from a log file, in accordance with at least one embodiment.

FIG. 6 is a block diagram illustrating an exemplary visualization server, in accordance with at least one embodiment.

FIG. 7 is a schematic diagram illustrating an exemplary graphical user interface for providing diagnostic data, in accordance with at least one embodiment.

FIG. 8 is a block diagram illustrating an exemplary method for generating and presenting diagnostic data, in accordance with at least one embodiment.

FIG. 9 illustrates a block diagram for an exemplary device to perform the one or more techniques described herein.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

Certain embodiments of the present disclosure relate to devices, computer-readable medium, and methods for obtaining diagnostic data (e.g., power and performance metrics such as battery usage and central processing unit performance, call stack information, etc.), providing this data (and/or data generated from the diagnostic data) through an application programming interface (API) for developer access. This data may be used for the purpose of optimizing their applications. In the disclosed techniques, a processor can receive an execution trigger from a third-party application informing a data logging routine operating at a device to collect diagnostic data. “Diagnostic data,” as referred herein, can include one or more raw data metrics, call stack information regarding any suitable number of processes, or the like. The execution trigger may be general to the application or may be specific for a particular routine of the application (e.g., a video streaming routine of a social media application). The methods described herein may include determining how identifiers are used to customize what diagnostic data is collected. The techniques described here are used to determine which metrics to measure, which logs to collect and/or aggregate, and provide instructions to system routines, which capture the raw data metrics and/or log files. As examples, the diagnostic data may be captured from any suitable combination of the device kernel in the one or more processors, a logging routine of the operating system (e.g., iOS), and/or a hardware logging routine. The diagnostic data can be stored in a persistent storage periodically throughout the day (e.g., N time per day). At any suitable time, the system may process the collected diagnostic data. In some embodiments, processing the collected diagnostic data may include aggregating multiple log files, reformatting log files, filtering data, summarizing or otherwise aggregating raw data metrics, or the like. The processed diagnostic data can be sent to an aggregation server.

The aggregation server may be configured to collect diagnostic data for various devices and can process metadata (e.g., device information for the device from which the diagnostic data was collected) accompanying the received diagnostic data to determine the classification and model of the electronic devices running the application. In some embodiments, the aggregation server may group (e.g., by value range, by operational metric, by hang time issue, etc.) diagnostic data corresponding to a particular third-party application together prior to providing such data to a visualization server.

When multiple log files have been received (e.g., log files corresponding to call stack information corresponding to any suitable number of processes executing a given third-party application), the aggregation server may execute operations for grouping the log files for a given third-party application based at least in part on a set of common call path signatures identified between log files. By way of example, the aggregation server may process the log files to identify call path signatures. The log files may initially express call stack information using a nested, tree-like format that identifies code locations from identifying what method/function calls have been initiated. The tree-like format of the call stack information may indicate a root function and various leaf functions initiated from that root function, directly, or via any suitable number of intermediate functions which are also indicated. The aggregation server may generate a call path signature for each path of each log file. The call path signature may indicate a sequential ordering of method/function calls (e.g., from root function to leaf function). The aggregation server may identify that two log files are to be grouped (e.g., associated with a common issue) based at least in part on identifying that each log file includes one or more common call path signatures. In some embodiments, this assessment may be based at least in part on identifying that each log includes a threshold number (e.g., 5, 10, 16, etc.) common call path signatures. In some embodiments, each log file may be grouped based at least in part on identifying that the common call path signatures occur in the same sequence, not necessarily contiguously within the respective log file. Once log files are group into any suitable number of groups, the aggregation server may select a predefined number of original log files corresponding to each group. A visualization server may present any suitable portion of the diagnostic data on a display in a manner to be easily reviewed and analyzed by the developer.

The visualization server can present any suitable number of user interfaces and receive user inputs (e.g., developer inputs) via those interfaces to customize the manner with which the diagnostic data is displayed for analysis. In some embodiments, the visualization server may be configured to reformat and/or filter diagnostic data received from the aggregation server to improve the user's ability to synthesize the data. By way of example, the visualization server can filter any suitable data from the diagnostic data according to predefined filtering rules. In some embodiments, the filtered data may be identified based at least in part on comparing any suitable portion of the call stack information (e.g., method calls, argument lists, line numbers, application identification information, etc.) to a predefined list of similar data (e.g., any suitable combination of predefined method calls, predefined argument lists, predefined line numbers, predefined application identification information, etc.).

As used herein, a metric data record may include raw data from an electronic device that is a measure of an operation of the device. As used herein, an “operational metric” refers to a value calculated from one or more metric data records that can be used to measure an operational condition of an application (e.g., power consumption or performance of an application). As used herein, a “classification” is used to describe a general description of an electronic device (e.g., a tablet or a smartphone). As used herein, a “model” describes a specific embodiment (e.g., an iPhone X, or iPhone 8, etc.) of an electronic device of a particular class (e.g., a smartphone). As used herein, a “data structure” refers a collection of data values, the relationships among them, and the functions or operations that can be applied to the data. A data structure can comprise a number of clusters where each cluster comprises a segmented range of values.

1. Data Ingestion and Processing

The techniques disclosed herein can include a method for performing data ingestion and processing diagnostic data (e.g., processing log files, processing raw data that can be used to calculate one or more operational metrics, etc.). The diagnostic data can be captured from the device kernel, a logging routine (e.g., Powerlog) of the operating system (e.g., iOS), a hardware logging routine (e.g., Signpost), or any suitable combination of the above.

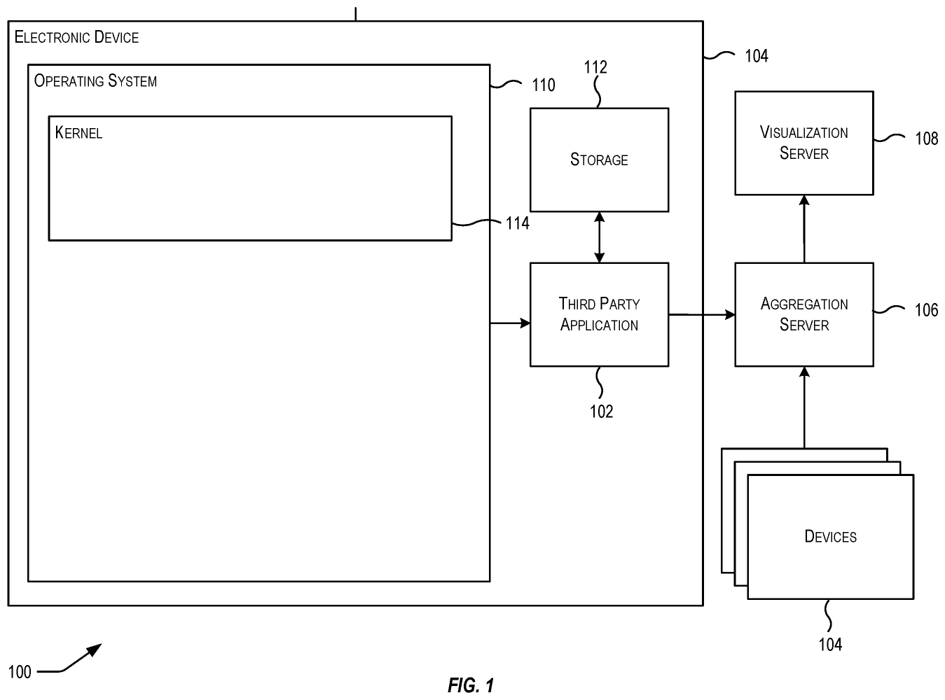

FIG. 1 illustrates a simplified, exemplary diagram of a system 100 configured to obtain, aggregate, process, and visualize diagnostic data for evaluating and/or debugging errors (e.g., hanging issues, performance issues, etc.) in third-party application 102, in accordance with at least one embodiment. A third-party application 102 is a program (e.g., an application), created by a developer that is different from the manufacturer of the electronic device, which executes at the electronic device 104. By way of example, the developer may be a website provider or may be associated with a provider of a website that offers access to the application. The third-party application 102 can be loaded into a memory of the device and be executed by one or more processors of the device. A third-party application 102 can present information to a user on a display of the electronic device 104.

The system 100 can include one or more electronic devices 104, an aggregation server 106, and a visualization server 108. The electronic devices 104 can include, but are not limited to, a smartphone, a tablet, a portable computer, or a wearable device. The electronic devices 104 may be associated with various classifications as well as different models of devices. The electronic device 104 can execute an operating system 110 to execute one or more instructions from a plurality of code stored in a memory 112 on the electronic device 104. An operating system (OS) 110 is a system software that manages hardware and software resources and provides common services for programs (e.g., applications). A kernel 114 is the central part of an operating system 110. The kernel 114 manages the operations of the electronic device 104 and the hardware, most notably memory and central processing unit (CPU) time. The aggregation server 106 may collect diagnostic data for a plurality of different electronic devices 104. In some embodiments, the aggregation server 106 may derive (e.g., identify and/or calculate) various operational metrics from the diagnostic data. In some embodiments, the aggregation server 106 may group diagnostic data corresponding to a particular third-party application together prior to providing such data to a visualization server. The visualization server 108 may receive aggregated operational metric data in order to display aspect of the diagnostic data (e.g., portions of log files, operational metrics, etc.) for evaluation of the performance of third-party application 102.

The visualization server 108 can present and/or host any suitable number of user interfaces and receive user inputs (e.g., developer inputs) via those interfaces to enable user interaction with the diagnostic data. In some embodiments, the visualization server 108 may be configured to reformat and/or filter diagnostic data received from the aggregation server 106. By way of example, the visualization server 108 can filter any suitable data from the diagnostic data according to predefined filtering rules. In some embodiments, the filtered data may be identified based at least in part on comparing any suitable portion of the call stack information (e.g., timestamped method/function calls with corresponding argument lists, line numbers, application identification information, etc.) to a predefined list of method/function names.

The visualization server 108 may group the log files for a given third-party application based at least in part on a set of common call path signatures identified between log files. Each group may be associated with a different operational issue (e.g., a delay identified during execution of the third-party application). The visualization server 108 may process the log files to identify call path signatures. As discussed above, the log files may initially express call stack information using a nested, tree-like format that identifies code locations (e.g., indicated using function/method call name, line numbers, or the like) from which method/function calls have been initiated. The tree-like format may indicate a root function and various leaf functions initiated from that root function, directly, or via any suitable number of intermediate functions that are indicated (e.g., via intermediate nodes of the tree between the root function and a particular leaf function). The visualization server 108 may generate a call path signature for each call path of each log file. The call path signature may indicate a sequential ordering of method/function calls (e.g., corresponding to a path of the tree from root function to leaf function). In some embodiments, the visualization server 108 may utilize a predefined rule set to identify particular call path signatures of interest (e.g., call path signatures that indicate data is being/has been written). The visualization server 108 may identify that two log files are to be grouped, and thus, associated with a common issue based at least in part on identifying that each log file includes one or more common call path signatures. In some embodiments, this assessment may be based at least in part on identifying that each log includes a threshold number (e.g., 5, 10, 16, etc.) common call path signatures. In some embodiments, each log file may be grouped based at least in part on identifying that the common call path signatures occur in the same sequence, not necessarily contiguously within the respective log file. In some embodiments, only call path signatures identified as being of interest may be processed for grouping purposes. Once log files are grouped into any suitable number of groups, the visualization server 108 may select a predefined number of original log files for each group. The visualization server 108 may present any suitable portion of the diagnostic data on a display in a manner enabling easy review and analysis by the developer.

In some embodiments, the visualization server 108 may calculate a priority value (e.g., a ranking, and/or score) for each group of files. In some embodiments, this priority value may be calculated based at least in part on calculating, from the log files of the group, a total execution time calculated from respective execution times for each of the respective methods/functions to reach completion. In some embodiments, the visualization server 108 may identify, for each group, a corresponding percentage of delay that may be attributable to the group with respect to a total delay calculated for all groups. In some embodiments, the delay for each group and/or the delay for all groups can be identified based at least in part on hang times obtained from the electronic devices and provided with the diagnostic data.

In some embodiments, the functionality provided by the aggregation server 106 and the visualization server 108 may be provided by a single device or distributed amongst two or more devices in the same or different manner as depicted in FIG. 1.

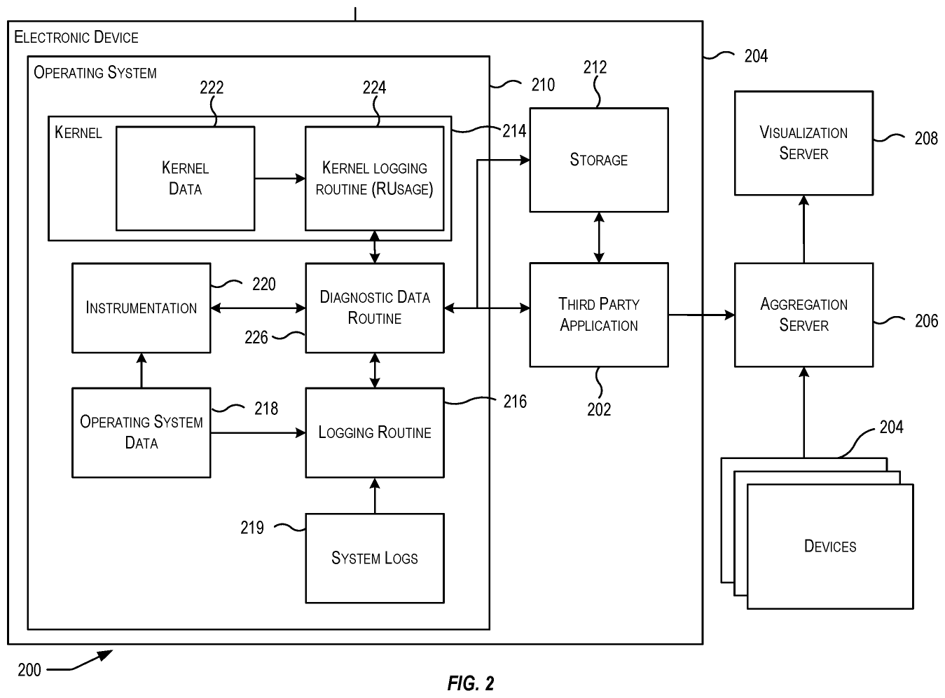

FIG. 2 provides additional details for the system 100 described in FIG. 1. The third party application 202 (an example of the third-party application 102 of FIG. 1) can transmit an identifier to the operating system 210, in accordance with at least one embodiment. The identifier can cause the diagnostic data routine 226 to execute a process to collect diagnostic data (e.g., any suitable of log tiles and/or metric records). In some embodiments, the identifier can inform (e.g., based on predefined rules) the diagnostic data routine 226 of the types of logs and/or metric data to be collected. In some embodiments, a developer can register the third party application 202 with the operating system developer. The application registration process can be used to provide information on the third party application 202 and can inform the diagnostic data routine 226 of the specific diagnostic data that is to be collected.

The operating system 210 of the electronic device 204 may include various logging routines 216. In various embodiments, the logging routines may continuously capture data generated by the operating system of the device and save the data in a persistent storage (e.g., a memory). The logging routine 216 may capture operating system data 218 (e.g., foreground time, background time, networking bytes (per application), and location activity). The logging routine 216 may collect the operational system data 218 and provide it to diagnostic data routine 226. The logging routine 216 may capture system logs 219 which may include any suitable number of log files corresponding to execution of the third-party application.

The logging routine 216 may collect metrics related to any suitable combination of: central processing unit (CPU) time, graphics processing unit (GPU) time, CPU instructions, average pixel luminance, cellular networking conditions, number of logical writes, and memory usage. The logging routine 216 may capture snapshots for these metrics for all processes and applications running on the operating system 210, possibly from different data sources, at any suitable time (e.g., at significant battery change (SBC) events). Significant battery change events may occur when there is a change in the electronic devices' battery level during the course of normal usage of the device. The logging routine 216 may allow for additional snapshotting at other important system level events. In some embodiments, the logging routine 216 may summarize these metrics with respect to each application from a previous time period (e.g., 24 hours from midnight to midnight of a previous day) and may deliver the payload to the diagnostic data routine 226 over a cross-process communication platform (e.g., XPC). Upon receiving this data, the diagnostic data routine 226 may store this data in storage 212 (e.g., a local persistent storage of electronic device 204).

Kernel 214 may generate any suitable number of instances of kernel data 222 may be generated. The kernel data 222 can include CPU and/or GPU time, a number of logical writes to a solid-state device (SSD), and a measurement of memory usage. A kernel logging routine 224 may collect the kernel data 222 and provide it to the diagnostic data routine 226. The kernel data 222 may be stored (e.g., by the kernel logging routine 224 of the kernel 214 and in the storage 212).

As detailed above, the data from different sources on the operating system 210 including the kernel logging routine 224, may be snapshotted or otherwise obtained by the logging routine 216 and delivered to the diagnostic data routine 226 once/day over a cross-process communication platform (e.g., XPC). The kernel logging routine 224 may maintain various cumulative counters per process (e.g., CPU time, GPU time, CPU instructions etc.) which are continuously updated in memory during the execution of these processes.

The operating system 210 may include instrumentation 220. The instrumentation 220 may be used for selective capture of one or more operational metrics surrounding a particular event, during a discrete time period, and/or during execution of a particular feature of third party application 202. The instrumentation 220 may log system level data (e.g., launch and resume times, hang durations, frame rates). In addition, the instrumentation 220 may set operating system (OS) regional markers to evaluate features of the third party application 202. The OS regional markers may be used (e.g., by the instrumentation 220 or another component) to evaluate CPU time, number of CPU instructions, current and peak memory, and logical writes.

Custom logging routine markers (e.g., MXSignposts) may be built on top of operating system routine region markers (e.g., os_signpost). Custom logging routines may provide a snapshot of a subset of metrics for its process from the kernel logging routine 224 and may store this data (e.g., in a metadata field of the operational regional markers). Custom logging routines allow developers to mark critical sections of their code and collect power and performance metrics for those marked sections.

For the system level signpost data, developers may internally instrument different parts of the system. For example, launch times may be measured by instrumenting the device operating system manager for handling foreground tasks (e.g., Frontboard) with operating system markers (e.g., os_signposts). Custom logging routine markers (e.g., MXSignposts) may be distinguished by the system from the other operating system markers (e.g., os_signposts) (e.g., by using the subsystem field value of os_signposts). Custom logging routine markers may be tagged internally with a subsystem value unique to the customer logging routine markers.

The third party application 202 may collect the diagnostic data (collected from the diagnostic data routine 226) and may save the diagnostic data to storage 212. In addition, the third-party application may transmit the diagnostic data to other devices different from the electronic device 204. The metric record data may be transferred over a network (e.g., the Internet). The diagnostic data may be aggregated with diagnostic data from other devices in the aggregation server 206. The aggregation server 206 may decode the diagnostic data. A plurality of metadata may accompany the diagnostic data. The plurality of metadata may identify the classification of model of the electronic device 204 from which the data originated. The aggregation server 206 may save any suitable portion of the diagnostic data to one or more a data structures based at least in part on the type and/or value of that portion of the diagnostic data. The aggregation server 206 may allow for efficient analysis of the diagnostic data.

The visualization server 208 may receive aggregated operational metric data and display the data (e.g., for evaluation of the performance of third party application 202). In some embodiments, the functionality of the aggregation server 206 (an example of the aggregation server 106 of FIG. 1) and the visualization server 208 (an example of the visualization server 108 of FIG. 1) may be provided by a single device or distributed amongst two or more devices in the same or different manner as depicted in FIG. 2.

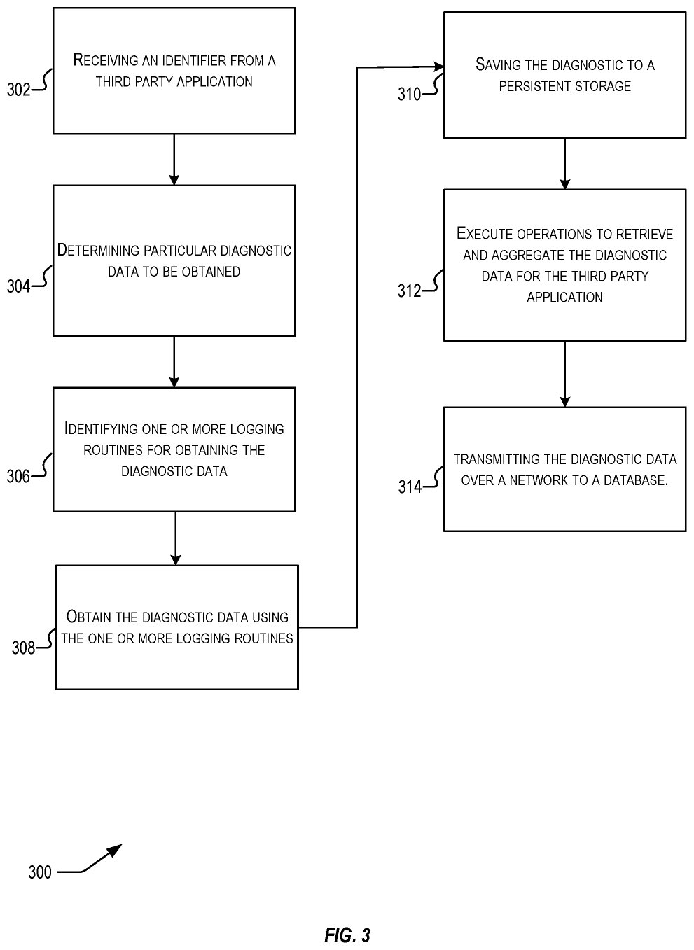

FIG. 3 illustrates a flowchart for a method 300 for ingesting and processing data, in accordance with at least one embodiment. In some embodiments, the method 300 may be performed, in whole or in part, by the diagnostic data routine 226 of FIG. 2. In some embodiments, the diagnostic data routine 226 is another application executing at the electronic device.

At 302, an identifier may be received from an application (e.g., third party application 202) on an electronic device. The application may be a third-party application, meaning that the application was developed by a party different from the developer of the operating system. The electronic device may be smart phone (e.g., an iPhone), a wearable device (e.g., an iWatch), a tablet (e.g., iPad), a portable electric device, a desktop computer, or the like. In some embodiments, the application may be configured to transmit the identifier when a predefined condition is met. By way of example, the third-party application may be configured to transmit the identifier periodically or based at least in part on a schedule. In some embodiments, the third-party application may be configured to transmit the identifier based at least in part on identifying that a sampling threshold condition has been met (e.g., 10-50 milliseconds (ms) of delay has occurred) during execution of the third-party application. In some embodiments, an indicator may be transmitted to the identifier to indicate that process call-stacks are to be sampled and the corresponding log files are to be stored in persistent storage (e.g., storage 212 of FIG. 2). The third-party application may utilize any suitable number of predefined rules for transmitting the identifier and/or indicator. As another example, the third-party application may be configured to identify when the application has experienced delay that meets or exceeds a reporting threshold condition (e.g., a delay of 250 milliseconds (ms), 500 ms, 1000 ms, etc. has occurred during execution of the application). The value of the reporting threshold condition may be greater than the value of other threshold conditions (e.g., the value of the sampling threshold condition discussed above). In response to identifying the reporting threshold condition has been met, the third party application 202 may transmit the identifier with an indicator indicating that another sampling is to be taken and aggregated with the previously stored log files and the collective log files transmitted to an aggregation server (e.g., the aggregation server 206 of FIG. 2) for processing.

At 304, the particular diagnostic data to be obtained (e.g., collected, retrieved, identified, etc.) may be determined. In some embodiments, the diagnostic data may include but is not limited to: CPU/GPU time, foreground/background time, networking bytes per application, location activity, average pixel/picture luminance, cellular networking conditions, peak memory, number of logical writes, launch and resume times, frame rate metrics, hang times, system logs, and/or the like. Any suitable aspect of the diagnostic data to be collected (e.g., the type and/or location of the diagnostic data to be collected) may be specified by a developer during registration of the application (e.g., when registering the third-party application with the diagnostic data routine 226). In some embodiments, the particular diagnostic data to be obtained may be generic to all applications (e.g., application launch time) or may be specific to the type of application.

At 306, one or more logging routines (e.g., predefined operations) for obtaining the diagnostic data may be identified. In some embodiments, the one or more logging routines may include but are not limited to kernel instrumentation (e.g., rusage/coalitions), operating system instrumentation, framework instrumentation (e.g., Signpost), and hardware/driver instrumentation. During registration of an application with an application performance routine, a developer may indicate the diagnostic data (e.g., operational metrics, log files, etc.) she desires to monitor for performance of the application. Based on this registration, one or more logging routines best suited to obtain the diagnostic data may be identified.

In some embodiments, the central processing unit (CPU) time may be a desired operational metric. CPU time may be a measure of the amount of time that an application spends processing information on the CPU. For measuring the CPU time, a unix counter routine can be selected as the logging routine. A kernel logging routine (e.g., kernel logging routine 224 of FIG. 2) may aggregate CPU time for each process on the electronic device. In some embodiments, the CPU time may be aggregated into discrete time intervals. The aggregated data may be saved in the persistent storage (e.g., storage 212 of FIG. 2).

In some embodiments, the graphics processing unit (GPU) time may be a desired operational metric. GPU time may be a measure of the amount of time that an application spends processing graphics information on the GPU. For measuring the GPU time, a Unix counter routine may be selected as the logging routine. A kernel logging routine (e.g., kernel logging routine 224) may aggregate GPU time for each process on the electronic device. In some embodiments, the GPU time may be aggregated into discrete time intervals. The aggregated data may be saved in the persistent storage (e.g., storage 212).

In some embodiments, the cellular condition time may be a desired operational metric. Cellular condition time may measure an elapsed time that the electronic device spends in one of a plurality of defined cellular conditions, where the cellular conditions include a type of network connection and network properties. For measuring the cellular condition time, a cellular monitoring routine may be selected as the logging routine. The baseband firmware of the electronic device may provide event-based updates on current cellular conditions for the electronic device. A logging routine (e.g., logging routine 216 of FIG. 2) may aggregate the cellular condition time per process. The aggregated cellular condition time can be stored to a persistent storage device.

In some embodiments, the application mode time data may be a desired operational metric. The application mode time may measure the elapsed time the application spends running in either the foreground or the background. For example, the application may be executed in either the foreground (meaning the application user interface is presented in at least a portion of the device display) or in a background (meaning that the application user interface is not presented in any portion of the device display). A mode detection routine may detect when the application is running and measure the elapsed time it runs in a foreground or in a background mode. The logging routine may aggregate the mode time data (e.g., foreground or background) per application. The aggregated mode time data may be stored to a persistent storage device.

In some embodiments, the location acquisition time may be a desired operational metric. Techniques to determine the precise location of the electronic device may be affect power consumption. The time spent acquiring a precise location and the degree of precision attained may be measured by a location acquisition routine. The location acquisition routine may measure time acquiring a location for different accuracy levels. The location acquisition time may be aggregated (e.g., by logging routine 216) by accuracy levels and saved to a persistent storage device.

In some embodiments, the average pixel luminance for the display may be a desired operational metric. Pixel luminance may identify/determine the brightness of a pixel on a display. The average pixel luminance may be a numerical average of the measure of the brightness of all the pixels on the display. In general, the higher the average pixel luminance, the greater the power consumption. A pixel luminance detection routine may measure an average of pixel luminance for the display. A logging routine (e.g., logging routine 216) may aggregate the measured average pixel luminance by application. The aggregated data may be saved to a persistent storage device (e.g., storage 212).

In some embodiments, the network transfer bytes may be a desired operational metric. The number of bytes transmitted and/or received over a network device can also contribute to power consumption. In general, the higher the number of network transfer bytes, the greater the power consumption. The data transfer routine may measure the number of bytes transferred by and received by the electronic device. A logging routine (e.g., logging routine 216) may aggregate the number of bytes per application. The aggregated data may be saved to a persistent storage device (e.g., storage 212).

In some embodiments, the application response time may be a desired operational metric. A hang tracer routine may measure the amount of time that an application spends being unresponsive to user input. This time may also be referred to as a “performance delay,” or “delay” for brevity. The application response time may be aggregated by an application (e.g., third party application 202) and the data may be stored to a persistent storage device (e.g., storage 212).

In some embodiments, the application launch time may be a desired operational metric. A launch time routine may measure an elapsed time between receiving a selection of an application icon and drawing a first visible pixel on a display of the electronic device. The application launch time may be aggregated by an application (e.g., third party application 202) and saved to a persistent storage device (e.g., storage 212).

In some embodiments, the application resume time may be a desired operational metric. A launch time routine may measure an elapsed time between receiving a selection of an application icon and re-drawing a first visible pixel on a display of the electronic device. The application launch time may be aggregated by application (e.g., third party application 202) and saved to a persistent storage device (e.g., storage 212).

In some embodiments, the number of logical writes may be a desired operational metric. Solid state storage devices have a limited number of logical writes. The greater the number of logical writes to a solid-state storage device reduces the life of the flash memory of the solid-state storage device. The number of logical writes may be aggregated over a discrete time period (e.g., a day) (e.g., by third party application 202). The number of logical writes may be saved to a persistent storage device (e.g., storage 212).

At 308, diagnostic data may be obtained corresponding to the execution of the third-party application using any suitable combination of the one or more logging routines described herein.

At 310, the diagnostic data may be saved to a persistent storage (e.g., storage 212). In some embodiments, the diagnostic data may be saved by the logging routines. In some embodiments, the persistent storage may be the memory of the electronic device, or the persistent storage may be an external storage device separate from the electronic device. In addition to the metric record data, device metadata (e.g., data that identifies the class and model or other device data of the electronic device from which the diagnostic data was obtained) may be stored. In various embodiments, an identification of the third-party application, a version indicator of the third-party application, a version of the operating system of the electronic device, and/or the like may be stored. The diagnostic data may be stored in data structures. In some embodiments, the diagnostic data obtained may be erased after it is transferred to a database.

At 312, operations may be executed to retrieve and aggregate the diagnostic data for the third-party application. For a given electronic device, different applications can be monitored. In other words, the storage may include diagnostic data corresponding to any suitable number of third-party applications. Additionally, or alternatively, different features of a particular application may be monitored and evaluated. An aggregation routine may collect the diagnostic data for a particular application or particular feature for transmission to a database.

At 314, the diagnostic data corresponding to the third-party application may be transmitted over a network to a database. In some embodiments, a wireless connection may be established with the database (e.g., through the Internet) to transfer the diagnostic data. In some embodiments, the diagnostic data is transferred over a wired connection. In some embodiments, the diagnostic data is transferred according to a predefined periodicity or schedule. In some embodiments, the diagnostic data may be transferred on demand. In some embodiments, the technique may transfer data on an ad hoc basis. In some embodiments, all diagnostic data not previously sent to the database may be transmitted during a transmission session. In various embodiments, the diagnostic data may be transferred incrementally. In some embodiments, the diagnostic data may be transmitted as aggregated data. In some embodiments, the diagnostic data for several different monitored application can be transmitted in one session. In some embodiments, the developer can access the diagnostic data transferred to the database through a developer interface (e.g., an interface provided by the diagnostic data routine 226).

It should be appreciated that the specific steps illustrated in FIG. 3 provide particular techniques for obtaining (e.g., ingesting) and processing (e.g., aggregating) diagnostic data for a third-party application according to various embodiments of the present disclosure. Other sequences of steps may additionally or alternatively be performed according to alternative embodiments. For example, alternative embodiments of the present disclosure may perform the steps outlined above in a different order. Moreover, the individual steps illustrated in FIG. 3 may include multiple sub-steps that may be performed in various sequences as appropriate to the individual step. Furthermore, additional steps may be added or removed depending on the particular applications. One of ordinary skill in the art would recognize many variations, modifications, and alternatives.

In some embodiments, developers may like to evaluate a particular feature of an application. For example, a social media application may include a streaming media feature as part of the application. The feature may not continuously run on the application. A developer may wish to obtain diagnostic data (e.g., operational metrics (e.g., power and performance metrics) and/or log files) for the application during the operation of the feature. Regional markers may be used to note the start and end of the feature so that operational metrics and/or log file entries between the start time and end time are collected to evaluate the performance and/or to debug errors (e.g., a hanging error identified based at least in part on determining a delay during which the main function of the application is unresponsive exceeds a threshold value) for this feature.

2. Operational Metrics

The operational metrics discussed herein are categorized into two categories: power metrics and performance metrics. The power metrics capture raw data and may be used to calculate the power requirements for particular aspects of an application. Excessive power consumption can be a source of customer dissatisfaction and often developers are concerned with monitoring and, to the extent possible, minimizing power consumption for an application. The power consumption metrics may include, but are not limited to, a central processing unit (CPU)/graphics processing unit (GPU) time, a foreground and/or background processing time, a number of networking bytes (per application) over a time period, location activity, display average pixel luminance, and/or cellular networking conditions.

The operational metrics may include one or more performance metrics. The performance metrics may be used to measure application performance, particularly those that consumers are concerned with. The performance metrics may include, but are not limited to, a measurement of peak memory, a number of logical writes to a solid-state device, one or more launch and/or resume times, one or more frame rate metrics, and one or more application hang times.

The techniques described herein may include evaluating a feature (e.g., a streaming feature) for third-party applications. By using region markers, metrics may be evaluated such as CPU time, a number of CPU instructions, current and peak memory usage, and number of logical writes to solid state device for the marked region of the application.

A. Power Metrics

i. Central Processing Unit/Graphics Processing Unit Time

Central Processing Unit (CPU) time for an application refers to an amount of time that an application spends processing and using the application processor (e.g., a processor of the device on which the application executes). CPU time includes any process for executing code to process any data, etc. Graphics Processing Unit (GPU) time refers to an amount of time that the application spends doing graphical processing using the GPU. Both CPUs and GPUs can be heavy energy consumers on electronic devices.

The raw data for CPU/GPU time may be obtained by the kernel using Unix counters attributing hardware usage to populate these metrics. The kernel (e.g., kernel 214) may aggregate these for each process on the system. A logging routine (e.g., logging routine 216 of FIG. 2) may aggregate CPU/GPU time in distinct time intervals (e.g., 5-minute intervals) and may save the aggregated information to persistent storage (e.g., storage 212). In some embodiments, an aggregated time may be determined for each process.

RUsage/Coalitions data may be computed in the kernel and aggregated in user space. One or more Unix counters attributing hardware usage time may be used to populate this data. The kernel may aggregate these counters for each process in the system. A logging routine may aggregate in discrete time intervals (e.g., 5-30-minute time intervals) and may store the aggregated data to persistent storage. Aggregated times may be determined for each process of the application. The kernel, as part of its standard operating procedure, may aggregate this data for every process on the system as they run continuously. In some embodiments RUsage/Coalitions may provide data related to and/or actual CPU time, GPU time, CPU instructions, current and peak memory, and logical writes.

ii. Foreground/Background Time

Foreground time and background time refer to states in which an application is running on the system. Multimedia device applications (e.g., iOS) support multitasking. Multitasking enables multiple application to run in the foreground where the application is displayed, and a user can see the application(s) and interact with them. Applications can also run in the background during which the user does not necessarily interact with them, but the application is active/executing, perhaps performing maintenance activities, updating a user interface (UI), or the like. Foreground time and background time can be effective measures with respect to determining the overall energy consumption of the application. Energy consumption of applications running in the foreground can be different from the energy consumption of applications running in the background.

In addition to the total amount of energy consumption, the percentage of energy consumption for each state of the application can be useful. For example, users may have different expectations for energy usage for an application running in a foreground than they do for an application running in the background. If a user is not using a social media application and the application is draining five percent every hour, users would likely be dissatisfied with the amount of energy consumption. However, if the same energy drain were to be experienced while using the application, the energy drain may appear to be very reasonable. The ability for developers to understand energy consumption while the application is running in the foreground (i.e., on screen) and while the application is running in the background, can be very useful with respect to optimizing an application.

The operating system may provide data (e.g., operating system data 218 of FIG. 2) including time(s) in different application running modes (e.g., foreground time and background time). A logging routine (e.g., logging routine 216) may aggregate data per event and may accumulate totals per application. In some embodiments, cumulative time in each running mode may be identified and provided.

iii. Networking Bytes (per Application)

Networking bytes refers to an amount of networking upload and download consumed over cellular and Wi-Fi technologies. The baseband chip in the cellular case and the Wi-Fi chip can be heavy consumers of energy when the application is actively uploading or downloading data. Therefore, measuring the number of bytes that the application has uploaded and downloaded can be useful in understanding the overall network health of an application. Network information may be used to optimize use for cellular (e.g., attempting to limit cellular data transfer or deferring tasks) until Wi-Fi is available.

The networking bytes may be measured per channel. In some embodiments, cellular usage may be measured separately from Wi-Fi usage. In some embodiments, the metrics may further segregate uploading data transfer from downloading data transfer. If the same chip is used, Bluetooth communications may be counted with Wi-Fi usage. In some embodiments, Bluetooth data transfer may be separately monitored and measured.

iv. Location Activity

Location activity refers to an amount of time that an application spends acquiring the device's location. This metric may be run mode agnostic. The metric may indicate how much time an application is searching for the device's geographic position. The degree of accuracy of the geographic position may be determined. The degree of accuracy may have a direct impact on the energy consumed as may the amount of time the application spends to complete.

In some embodiments, the actual usage of the location framework on the operating system may be measured (e.g., the number of geofences set). Geofencing refers to a location-based service in which an app or other software uses GPS, RFID, Wi-Fi or cellular data to trigger a pre-programmed action when a mobile device or RFID tag enters or exits a virtual boundary set up around a geographical location, known as a geofence. These metrics may have an impact on the overall energy consumption of the application. For example, an application may have thousands of fences, which might end up waking the application repeatedly, causing an increase in power usage for potentially little benefit.

Location activity metrics may be differentiated between foreground and background modes. This may allow determining the energy for an application (e.g., a navigation application that provides real time navigation) for the purpose of understanding a rate of power consumption while actively using the application (e.g., while utilizing the navigation features) as compared with the rate of power drain otherwise experienced (e.g., while the application is using location for other features).

The information for location activity may be received from the operating system instrumentation. This time may be segregated for different accuracies. A location framework routine may provide event-based data on accuracy usage. The location framework routine may send sessions to the logging routine (e.g., logging routine 216) per process. The logging routine may aggregate this data from all sessions based on accuracy cluster (e.g., an accuracy range) and potentially per process. In this manner, a cumulative time spent in each accuracy cluster may be obtained.

v. Display Average Picture Luminance (APL)

On Organic Light Emitting Displays (OLED) displays, average picture luminance is extremely important for understanding how an applications user interface (UI) is impacting the energy consumption. Average Picture Luminance (APL) represents a percentage of OLED pixels that are lit up. The operating system interface through an APL routine may collect data to identify the average of the current pixel luminance. A logging routine (e.g., the logging routine 216) may intersect this data with collected application foreground data to determine daily averages. Time limited (e.g., daily) averages for the application may be obtained. In some embodiments, hardware and driver instrumentation may provide the display APL data metrics.

vi. Cellular Networking Conditions

Cellular networking conditions can cause increased energy consumption for electronic devices. In general, the weaker the signal strength, the more energy is required to transfer data. Conversely, the stronger the signal strength, the less energy required to transfer data. Therefore, understanding signal strength is helpful with respect to understanding the cellular conditions under which the data was transferred and the resulting power consumption experienced. In addition to signal strength, network congestion can also be an issue with cellular communications. For example, portions of the network may be congested while the remaining network is uncongested. In some embodiments, the device can receive information from the cellular tower itself, (e.g., latency, status, and health). If the network is overloaded, the network can be slowing down and providing less slots to transmit data. In additional, the type of network connection can also be captured (e.g., 3G, 4G (LTE), 5G, etc.)

The cellular network condition statistics may be provided to the logging routing (e.g., logging routine 216) by the baseband firmware. Baseband firmware may provide event-based updates on current cellular connectivity conditions. The logging routine may aggregate and store the cellular network condition data in a per process manner. From this data, a histogram of application time spent in different connectivity clusters may be obtained. In some embodiments, hardware and driver instrumentation may provide the cellular networking conditions data.

B. Performance Metrics

i. Peak Memory

Peak memory refers to a metric that can be measured to determine the performance of an application. The peak memory metric can indicate how the application is consuming memory. If the peak memory is very high, there are higher chances for the application to experience unexpected jetsam events when the application is running a certain mode. If memory consumption is too high (e.g., over a threshold) the system may need to reclaim that memory in order to provide a better user experience. Jetsam is a system process that monitors memory usage on an electronic device. Jetsam may trigger an event when memory usage of the device is high (e.g., over a threshold usage), and may reclaim memory from other apps to improve performance other applications running in the foreground. It may also force close any application (e.g., an application that does not voluntarily offer up the memory it uses).

A first indicator of high memory usage may include disappearance of the application from the display. It may appear like a crash to the user if the memory usage exceeds an extremely high threshold. A second indicator, which can be less obvious, related to unusually long launch times. For example, if an application uses more memory when the application is not open, then there is a higher chance that that application may no longer be kept in memory. Thus, when a user attempts to launch the application again, it will take much longer to open. Typically, when a user launches an application on an electronic device, it is already running on the device if a user has recently opened it so the launch will appear to be very quick to the user. This type of “launch” may refer to resuming an application versus a launch where the electronic device will have to fully launch the application.

There may be significant power implications to having high memory usage. Operating systems have memory management systems that reside in either the kernel or the OS, in order to manage the actual physical pages and virtual pages in memory. If an application is consuming a large amount of memory, the application may also be consuming a large amount of energy due to high CPU usage. This may be due to a virtual memory manager allocating large amounts of CPU to various threads to manage compressing data to free up memory that may be provided back to the application. Therefore, memory usage may affect power consumption. In some embodiments, peak memory data may be provided by kernel instrumentation (e.g., rusage4).

ii. Logical Writes

A solid-state drive (SSD) is a storage device that uses integrated circuit assemblies as memory or interconnected flash memories to store data persistently even without power. Unlike a hard disk drive or HDD that uses rotating metal platters or disks with magnetic coating to store data, an SSD has no mechanical or movable parts. One disadvantage of SSDs is due to having a shorter lifespan than hard disk drives because SSDs have a limited write cycle. The flash memories of a solid-state drive can only be used for a finite number of writes. An SSD cannot write a single bit of information without first erasing and then rewriting very large blocks of data at one time. As each cell goes through this cycle, it becomes more useless. However, this decaying process does not affect the read capability of the entire SSD.

Many electronic devices (e.g., smartphones, tablets) utilize SSDs. Therefore, it can be important to monitor and understand the number of logical writes an application running on the electronic device performs. In some embodiments, the number of logical writes performed on the file system by the application can be calculated and/or aggregated. Whenever an application decides to write a file or decides to sync any defaults or anything like that, it may incur an impact on the file system of the device. In some embodiments, the number of logical writes can be captured in the kernel (i.e., by r_usage) and aggregated within a ledger (e.g., a r_usage ledger). This metric may be helpful when attempting to assess how much duress the application is imparting on the file system and the flash memory of the SSD. In some embodiments, the number of logical writes may be provided by kernel instrumentation (e.g., rusage4).

iii. Launch and Resume Time

Launch and resume time may be another set of metrics that can be useful for developers. The slower the launch or resume time, the less desirable the application will be for consumers. Application launch time may be measured using a logging routine running in the OS. Launch time may be measured from the icon selection until the first visible draw on the display of the electronic device. Resume time may be measured from the time between the icon selection and the application redrawing on the display of the electronic device. Launch time and/or resume time may be provided as operating system data (e.g., operating system data 218).

iv. Frame Rates Metrics

Frame rate refers to a measure of the frequency at which frames in a screen graphics generation sequence are displayed. Frame rate may be a measure of how smooth the graphics display appears. In some embodiments, the frame rate can be 60 frames per second. In other embodiments, the frame rate can be 30 frames per second. In still other embodiments, the frame rate can be 15 frames per second. Dropped frame count may also be measured. An operating system may provide built in features that are used by third-party applications. One such feature can be scrolling the display for applications. Dropped frame rate may identify the number of frames that are dropped on average while performing an operation (e.g., scrolling on a display). Frame rate data can be provided by logging routines.

v. Hang Time

Hang time refers to a measurement of the amount of time applications spend being unresponsive to user input. In some embodiments, the hang time may be measured from a hangtracer routine on enabled devices. When enabled, a hangtracer routine may use thread watchdogs to detect the main thread of applications being blocked. After a sufficient period of time blocked, the hangtracer routine may generate an operating system marker (e.g., an os_signpost) for the event. An operating system daemon (e.g., XPC service) may collect the hang time information from the markers. In some embodiments, a logging routine may collect and aggregate these markers on a per process basis.

3. Diagnostic Data Aggregation

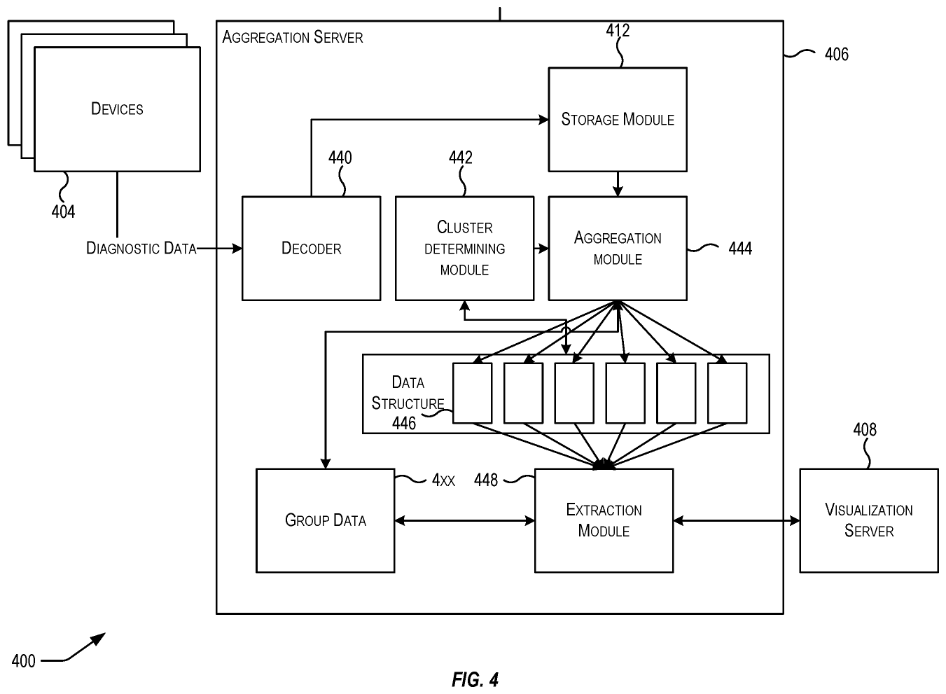

FIG. 4 is a block diagram illustrating an exemplary aggregation server 400. The aggregation server 406 may receive diagnostic data from any suitable number of devices 404 (each being an example of the electronic devices 104 and 204 of FIGS. 1 and 2, respectively). The diagnostic data may include (a) accompanying metadata that specifies a class of a device and a model of a device associated with the data record, (b) one or more operational metrics, (c) one or more log files corresponding to a third-party application, or any suitable combination of the above. In various embodiments, the metadata can identify the application to which the diagnostic data relates, the version of the application, the operating system, the version of the operating system, and the like.

In some embodiments, the diagnostic data may be provided by the devices 404 (e.g., electronic device) in encoded, compressed files. The decoder 440 may decode and/or decompress the diagnostic data and may store the decoded/decompressed diagnostic data in the storage module 412. Although the storage module 412 is depicted as being local to the aggregation server 406, in some embodiments, the storage module 412 may be on a separate device that is accessible to the aggregation server 406 via one or more wireless and/or wired connections.

For each version of a third-party application and operational metric, a cluster determining module 442 may determine a distribution of expected values for that metric. For example, for a hang time metric, the cluster determining module 442 may determine and/or generate a data structure with a number of clusters to capture incoming metric data (obtained from diagnostic data corresponding to a particular device) based on the value of the metric data. The clusters may correspond to centroids determined from a statistical analysis of the metric values. For example, the data structure for the hang time metric for version n of the third-party application may have a set of ten different clusters for number of hangs per hour of application use. Some embodiments may use more than 10 clusters and some embodiments may use less. The incoming data may be compared with the values assigned to each of the clusters. Similar data structures can be developed for the various operational metrics. Each data structure may include segmented ranges of values for a respective operational metric, in which each segmented range corresponds to a cluster of values of operational metrics, and where each of the data structures correspond to a class of devices or to a model of devices. For example, a particular data structure may store operational metrics for a smartphone class of devices. In various embodiments, the data structure may store operational metrics for a particular model of the device (e.g., an iPhone 6s). In some embodiments, the number of segmented ranges can vary (e.g., based on the distribution of the values of the operational data).

The aggregation module 444 may store and analyze the decoded metric data stored in a data structure 446 based on the classification (e.g., smartphone, tablet, etc.) and model (e.g., model of smartphone) associated with the device from which the metric data originated. The cluster determining module 442 may periodically re-evaluate the size and number of clusters as the data structure 446 is updated with new metric data. The number of clusters may vary for each operational metric to allow for rapid retrieval of statistically significant values for the operational metrics.

The aggregation module 444 may, for each operational metric of each metric data record, assign a record to a first data structure corresponding to the class and to a second data structure corresponding to the model of the device from which the metric data was obtained. The metadata accompanying the diagnostic data, with which the metric data record is associated, may identify the class and model of the device that generated the operational metric data record. The aggregation module 444 may reference the class and model metadata to assign each metric data record to one or more data structures. For example, metric data records from a particular manufacturer's smartphone can be assigned to both the data structure for smartphones and for the data structure corresponding to the phone's model. As the data structure for class relates to multiple models, the data structure for class may naturally include more data. The number of classes and models may change over time as new models and types of devices are developed. For example, future embodiments, may include a third class for wearable devices. Future models can include smartphones, tablets, and models for wearable devices.

The aggregation module 444 may assign any suitable metric data record to any suitable number of data structures. These data structures may represent groupings of the metric data record according to any suitable attribute of the records such as device type, model, value and/or value range of the operational metric. Any suitable data structure (e.g., data structure 446) may be stored in and retrieved from storage module 412.

The aggregation module 444 may determine a statistical value for the operational metrics in one or more of the segmented ranges. For each data structure, the segmented ranges allow for quick calculation of a statistical value for each of the operational metrics. By storing the data into segmented ranges, an average of a particular percentile may be quickly calculated for the values of the operational metrics. By way of example, a user may desire to see a value for an operational metric for a typical or 50^{th} percentile of devices. As the values for each segmented range is adjusted as new data is added, the techniques described herein allow the average value for the 50^{th} percentile to be determined without having to had to add individual values for millions of data entries from millions of devices and dividing by the number of devices. Using a clustered data structure allows for a statistical value to be more quickly calculated for one or more percentile classifications (e.g., 50^{th} percentile or 95% percentile).

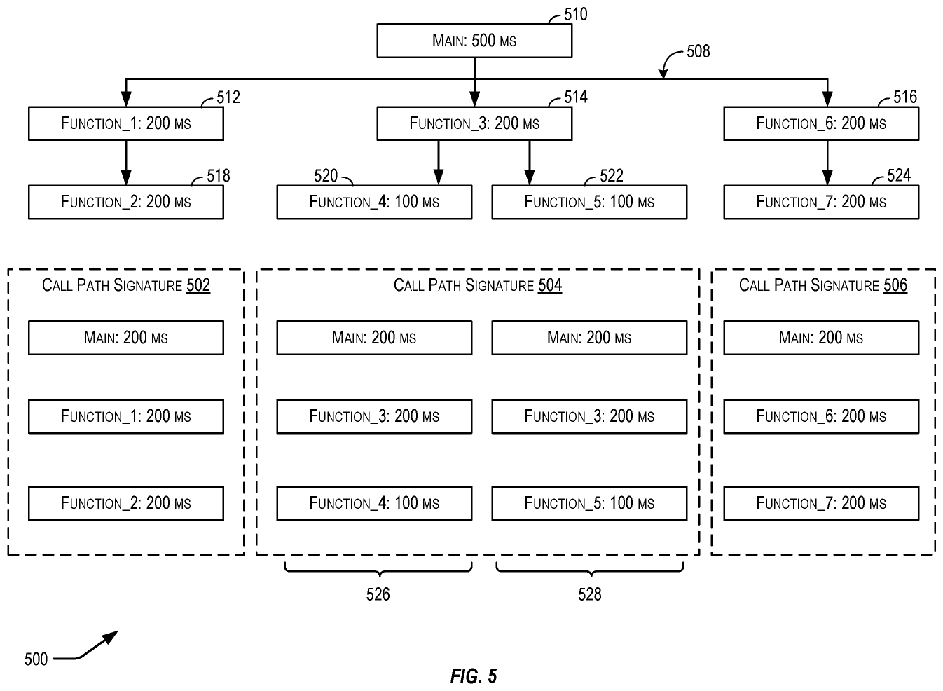

The aggregation module 444 may perform operations for grouping log files received as part of the diagnostic data. In some embodiments, the aggregation module 444 may process the received log files corresponding to a third-party application to identify call path signatures. The log files may initially express call stack information using a nested, tree-like format that identifies code locations from which method/function calls have been initiated. The tree-like format may indicate a root function and various leaf functions initiated from that root function, directly, or via any suitable number of intermediate functions which may also indicated. The aggregation module 444 may generate a call path signature for each path of each log file. FIG. 5 discusses in more detail a method for generating call path signatures. The call path signature may indicate a sequential ordering of method/function calls (e.g., from root function to leaf function including any intermediate functions of the path from root function to leaf function). The aggregation module 444 may identify that two (or more) log files are to be grouped (e.g., associated with a common hanging issue/error) based at least in part on identifying that each log file includes one or more common call path signatures. In some embodiments, this assessment may be based at least in part on identifying that each log includes a threshold number (e.g., 5, 10, 16, etc.) common call path signatures. In some embodiments, each log file may be grouped based at least in part on identifying that the common call path signatures occur in the same sequence, not necessarily contiguously within the respective log file. Once log files are grouped into any suitable number of groups, the aggregation module 444 may select a predefined number of original log files corresponding to each group. These log files may be selected based at least in part on a time or order in which they were received (e.g., the first 5 logs received, the first 10 logs received, etc.), a device from which the log files originated (e.g., to provide a log for each type of device from which log files were received), or the like. The log files, the selected log files, and the call path signatures for each group may be stored as group data 450. Group data 450 may be stored in and retrieved from storage module 412.

An extraction module 448 may retrieve/obtain operational data based at least in part on input provided at, and received from, the visualization server 408. For example, a developer may be interested in the battery performance for their application for older model device (e.g., iPhone 6). The developer can select “iPhones” for the class of devices. The “iPhone” class may include several different models of iPhones (e.g., iPhone 6, iPhone 6s, iPhone XS, iPhone XS Max). Selecting only the “iPhone” class would result in the extraction module providing data for all iPhone models with existing data, However, selecting “iPhone 6” for the model may only provide operational metric information (e.g., battery performance) for iPhone 6 devices. The extraction module 448 may provide operational values for a particular version of the application (e.g., version 3.0.1). In various embodiments, the extraction module 448 may provide operational values for multiple versions of the application. In some embodiments, the extraction module 448 may provide operational values for a selected number (i.e., significant versions) of the application. The query for the extraction module 448 may be a query for all software versions of a particular class, type, and operational metrics. The extraction module 448 may receive a request for certain operational metric data (e.g., power and performance metrics). The extraction module 448 may retrieve or otherwise obtain the values for the operational metrics from various data structures (e.g., the data structure 446).

An extraction module 448 may retrieve logging data based at least in part on input provided at and received from the visualization server 408. For example, a user (e.g., a developer) may select a particular group (e.g., corresponding to a particular hanging error) from a user interface provided by the visualization server 408.

FIG. 5 illustrates a block diagram illustrating an exemplary method 500 for generating call path signatures (e.g., call path signatures 502, 504, and 506) from a log file, in accordance with at least one embodiment. Method 500 may be performed by any suitable computing component (e.g., the aggregation server 406 of FIG. 4). Tree 508 represents the logging entries of a given log file. Each node in the tree 508 represents a corresponding function and/or method call within the log. The log file may be parsed and used to generate tree 508. In some embodiments, the root node of the tree (e.g., node 510) may represent a main function (also referred to herein as a “root function”) of a given third-party application. Each parent node (e.g., nodes 510, 512, 514, and 516) may include one or more child nodes that represent the function/method calls made within the function/method corresponding to a higher node in the tree 508. By way of example, nodes 512, 514, and 516 represent the function/method calls made within the main function represented by node 510. Node 518 represents a function/method call made by function 1, represented by node 512. Similarly, nodes 520 and 522 each represent a corresponding function call that is executed within function 3, represented by node 514. Node 524 represents a function/method call made by function 6, represented by node 516.

Completion of a function/method corresponding to each node may be dependent on the completion of each function/method corresponding to all of that node's children. Thus, the execution of function 3 may not be complete until the execution of functions 4 and 5 have been completed. Likewise, the main function represented by node 510 may not be complete until the operations of each function corresponding to nodes 512-524 have been completed. Each node may be associated with one or more operational metrics (e.g., a value representing the total execution time for that function). By way of example, function 1, represented by node 512, may be associated with a total execution time of 200 milliseconds (ms) based on its corresponding operational metric(s).

Once generated, tree 508 may be traversed to generate the call path signatures 502-506. Each call path signature represents one or more paths of tree 508. A path may correspond to a traversal from a root node (e.g., node 510), through one or more intermediate nodes (e.g., one of nodes 512, 514, or 516) to a leaf node corresponding to one of nodes 518-524. In some embodiments, a call path signature may include data indicating a sequence of function/method calls corresponding to one or more paths. By way of example, call path signature 502 may indicate one sequence of function/method calls that indicates that the main function called function 1, which in turn called function 2. Likewise, call path signature 506 may indicate a sequence of function/method calls that indicates that the main function called function 6, which in turn called function 7.

In some embodiments, a call path signature may include more than one sequence corresponding to a respective path of the tree. For example, call path signature 504 may include sequences 526 and 528 corresponding to all paths that share a subset of function calls. Call path signature 504 may include sequences 526 and 528 based at least in part on identifying that sequence 526 shares a portion of function/method calls with sequence 528 (e.g., main and function 3). These call path signatures may be used to compare call path signatures of another log file. If a threshold number of call path signatures match between the log files, the aggregation server 406 may group or otherwise associate the log files as corresponding to a common hang error.

4. Diagnostic Data Visualization

Visualizing diagnostic data (e.g., operational metrics and/or logging data) can be provided in a consolidated manner. A challenge is to depict multiple pieces of information to a developer in a way that is easy to analyze and make decisions. Interfaces for presenting diagnostic data may include one or more histograms, segmented circles, and/or bar graphs to effectively present data for rapid analysis.

The techniques discussed herein can be used to aggregate data from millions of devices to construct a web API endpoint from which an integrated development environment (e.g., Xcode) can connect and provide a developer a view of those metrics and/or logging data in the field. A focus is application developers who may not be able to develop their own analytics routines. In addition, it is desirable for a developer to select the classification and models to better understand the power and performance of the application for older devices as compared with newer devices with increased memory and battery capacity.

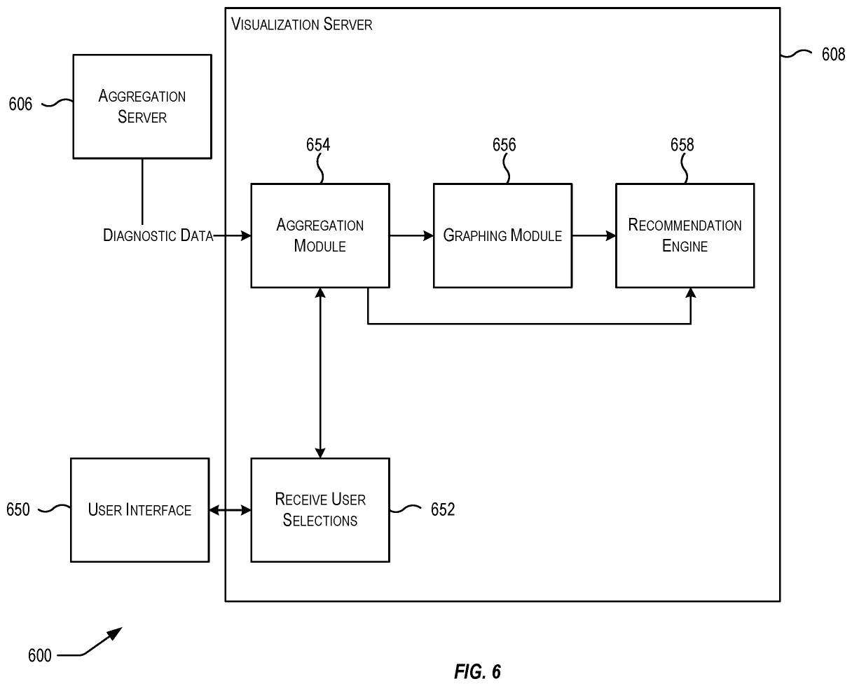

FIG. 6 is a block diagram illustrating an exemplary visualization server 600 (an example of the visualization servers 108 and 208 of FIGS. 1 and 2, respectively), in accordance with at least one embodiment. The visualization server 608 may receive and/or obtain the diagnostic data from the aggregation server 606. In some embodiments, the diagnostic data received from the aggregation server 606 (an example of the aggregation server 406 of FIG. 4) may differ from the initial diagnostic data received by the aggregation server 606 (e.g., from the devices 404 of FIG. 4). By way of example, the diagnostic data may be filtered based at least in part on one or more operations performed at the aggregation server 606. In some embodiments, the diagnostic data (e.g., log files) may be grouped according to common call path signatures identified by the aggregation server 606 in the manner discussed above in connection with FIGS. 4 and 5. The diagnostic data may include any suitable number of corresponding call path signatures associated with any suitable number of corresponding groups of log files. The diagnostic data may be received from the aggregation server 606 based at least in part on one or more selections (e.g., user selections 652) provided at the user interface 650.

The visualization server 608 may present one or more user interfaces (e.g., user interface 650 for a developer to enter selections (e.g., user selections 652) that may customize the display of the diagnostic data. These selections can include, but are not limited to, the classification and/or model of the device from which the data originated, selection of a grouping of logging data (e.g., a group corresponding to a particular hang time issue), selection of viewing a particular log file, selection of viewing one or more log files corresponding to a grouping, or the like. The visualization server 608 may be configured to request particular diagnostic data from the aggregation server 606 based at least in part on the user's selections.

In some embodiments, based on the selections of the user, operational metric data may be aggregated for clusters and sub-clusters by an aggregation module 654. In some embodiments, the aggregation module 654 may be configured to request the aggregated data from the aggregation server 606 via one or more requests. A graphing module 656 may receive the aggregated data. The graphing module 656 may be configured to generate display data corresponding to one or more graphs configured to present the aggregated data.

Visualization server 608 may include recommendation engine 658. Recommendation engine 658 may be configured to analyze the aggregated data received from the graphing module 656 and/or the aggregation module 654 to prepare one or more recommendations to be provided to the user. In some embodiments, the recommendation engine 658 may store a predefined list of know hanging issues. Each entry in the list may be associated with a call path signature associated with a given hanging issue and a recommendation indicating one or more actions to take to potentially resolve the issue. In some embodiments, the call path signature associated with a group of log files (corresponding to a given hang time issue) may be compared to the call path signatures within the list. If a match is found, the recommendation engine 658 may be configured to present, via the user interface 650, the recommendation corresponding to the known issue associated with the matching call path signature.

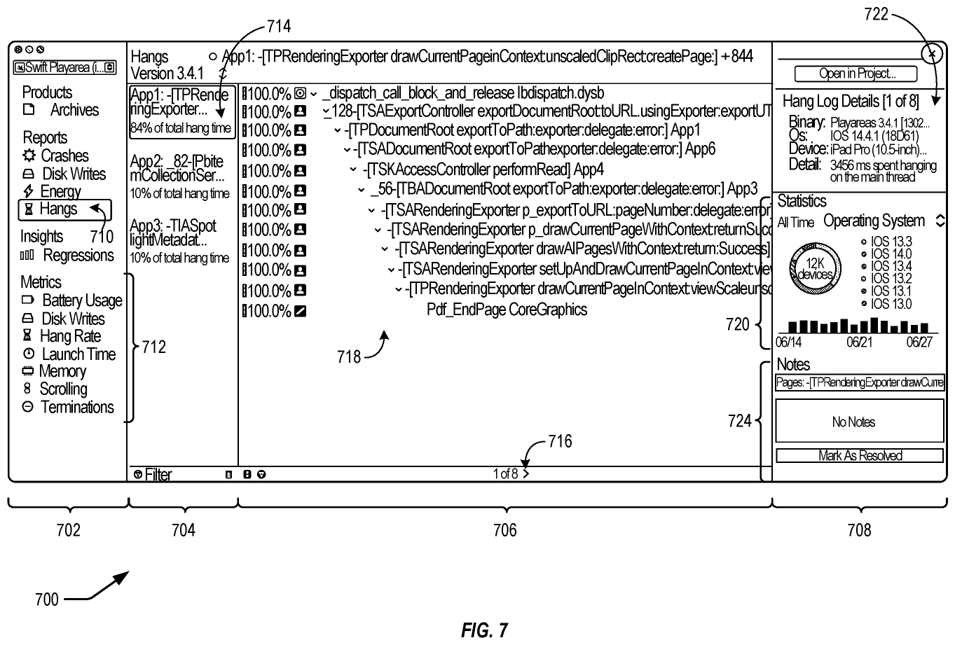

FIG. 7 is a schematic diagram illustrating an exemplary graphical user interface (GUI) 700 for providing diagnostic data, in accordance with at least one embodiment. GUI 700 is an example of the user interface 650 of FIG. 6 and may be hosted or otherwise provided by the visualization server 608 of FIG. 6.

GUI 700 may include a number of sections. As depicted, GUI 700 includes section 702, 704, 706, and 708. In some embodiments, section 702 may include any suitable number of navigational options. Selection of one of these options (e.g., option 710) may cause corresponding diagnostic data (e.g., log file groups, log file data, etc.) to be presented via any suitable combination of sections 704-708. Selection of any of the options 712 may cause corresponding operational metric to be displayed within the area populated by sections 704-708. In some embodiments, the operational metric(s) corresponding to a selection of one of options 712 may be presented in any suitable manner utilizing, for example, bar graphs, text, pie charts, histograms, or any suitable interface element configured to convey information about the operational metric(s).

Section 704 may include one or more options for selecting one or more detected hang issues. Each option with section 704 may correspond to a third-party application of one or more third-party applications. In some embodiments, multiple options of section 704 may correspond to multiple hang issues of a third-party application. The information depicted in section 704 may not be presented until option 710 has been selected. In some embodiments, data corresponding to the detected hang issues may not be requested (e.g., by the visualization server 608 of FIG. 6) until selection of option 710 has occurred. In other embodiments, the data may be requested at any suitable time, periodically, or according to a predefined schedule.

Each option may be presented with text indicating additional information regarding the selected hanging issue. By way of example, an option may present a particular function attributable to the hang/delay. As another example, an option may present a percentage of a total hang time corresponding to the third-party application that is attributable to the particular hanging issue associated with the option. As depicted, option 714 indicates a hanging issue with “App1,” at a function referred to as: “TPRenderingExporterdrawCurrentPageIn Context:viewscaleunscaleoClipRect.” Option 714 also indicates that the associated hanging issue is attributable to 84% of the total hang time (e.g., delay during which the application is unresponsive) experienced with the third-party application.

Each of the options in section 704 (e.g., option 714) may be associated with any suitable number of log files from a grouping of log files. As discussed above, each of the log files corresponding to a given option of section 704 may share a threshold number of call path signatures.

As depicted, option 714 corresponding to a particular hang issue has been selected. Based at least in part on this selection, section 706 may be updated to present log file data of a log file of the group of log files corresponding to the option 714. In the example depicted in FIG. 7, eight log files may be accessible via interface element 716, although any suitable number of log files (e.g., 4, 10, all available, etc.) may be accessible via interface element 716. The data of the first log file may be presented at 718 by default. Selection of interface element 716 may cause the next log file associated with the group to be presented at 718. Each of the entries depicted at 718 may be expandable to view finer granularity data. By way of example, log file data may be presented by default at a function/method level of granularity. By expanding any entry, log data corresponding to specific lines of code within the function may be viewed.

Section 708 may include any suitable operational metrics (e.g., operations metrics 720) associated with the third-party application corresponding to the selected option (here, option 714). Operational metrics 720 may include any suitable type and/or combination of operational metrics associated with the device(s) from which diagnostic data was attained, that was identified (e.g., by the aggregation server 406 of FIG. 4) as being associated with a common hanging issue.

Section 708 may include log metadata corresponding to the log file currently being viewed at 718. For example, the log file details may include, but are not limited to a identifier of a binary file, an operating system executed by the device from which the currently presented log file was obtained, device data (e.g., model, type, manufacturer, serial number, etc.) of the device from which the currently presented log file was obtained, detailed metadata (e.g., a total delay corresponding to the main thread of the third-party application experienced at the device, for example, 3456 ms), or the like.

In some embodiments, section 708 may include a notes section 724 with which the user may annotate the log file with any suitable information for subsequent use. The user input entered within notes section 724 may be stored as being associated with the log file. If the user navigates away from presenting a given log file, but later returns to viewing that log file, the previous notes provided at notes section 724 may be once again presented.

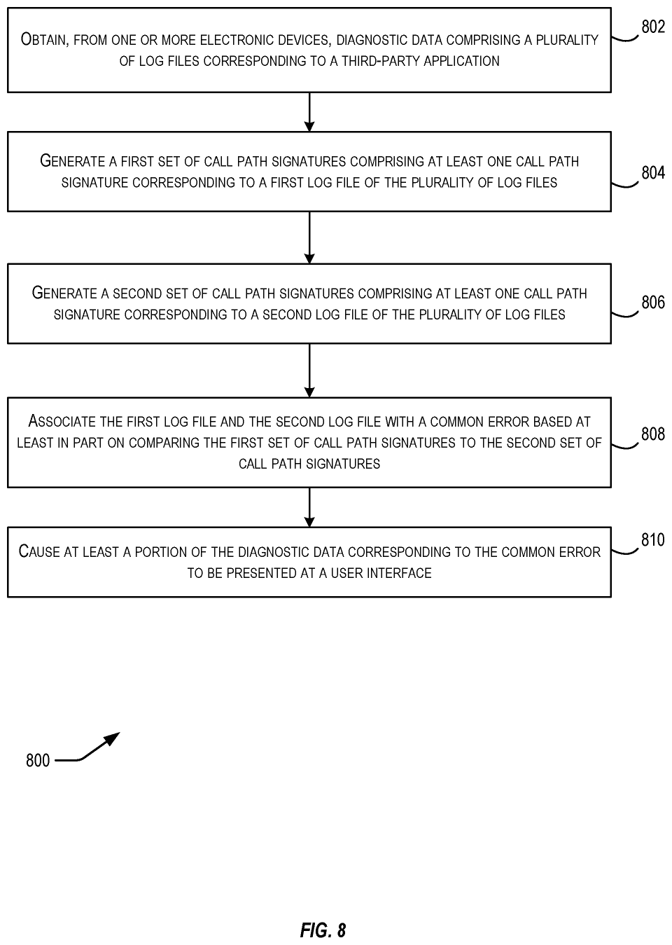

FIG. 8 is a block diagram illustrating an exemplary method 800 for identifying and presenting diagnostic data, in accordance with at least one embodiment. The method may be performed by any suitable combination of the aggregation server 406 of FIG. 4 and/or the visualization server 608 of FIG. 6. In some embodiments, the functionality discussed in connection with the aggregation server 406 and the visualization server 608 may be performed by a single device or multiple devices of a distributed system. The steps of method 800 may include more steps or fewer steps than those depicted in FIG. 8. The steps of method 800 may be performed in any suitable order.

The method 800 may begin at 802, where diagnostic data comprising a plurality of log files corresponding to a third-party application may be obtained from one or more electronic devices (e.g., the electronic device 104 of FIG. 1, the electronic device 204 of FIG. 2, devices 404 of FIG. 4, etc.). In some embodiments, the diagnostic data comprises one or more operational metrics obtained with at least one of the first log or the second log.

At 804, a first set of call path signatures is generated. Call path signatures 502-506 are examples of a call path signature. The first set of call path signatures may comprise at least one call path signature corresponding to a first log file of the plurality of log files. In some embodiments, each call path signature of the first set of call path signatures indicates a respective sequence of one or more functions calls of the first log file.

At 806, a second set of call path signatures is generated. The second set of call path signatures may comprise at least one call path signature corresponding to a second log file of the plurality of log files. In some embodiments, each call path signature of the second set of call path signatures indicates a respective sequence of one or more functions calls of the second log file.

At 808, the first log and the second log may be associated with a common error based at least in part on comparing the first set of call path signatures to the second set of call path signatures. In some embodiments, associating the first log and the second log with the common error further comprises identifying that the first set of call path signatures and the second set of call path signatures share a threshold number of common sequences.

At 810, operations may be executed to cause at least a portion of the diagnostic data corresponding to the common error to be presented at a user interface (e.g., the user interface 650 of FIG. 6, the graphical user interface (GUI) 700 of FIG. 7, etc.). in some embodiments, the portion of the diagnostic data presented at the user interface comprises the first log file. In some embodiments, the portion of the diagnostic data presented at the user interface comprises at least a portion of the one or more operational metrics, or data calculated using the portion of the one or more operational metrics. In some embodiments, the portion of the diagnostic data presented at the user interface comprises a subset of log files selected from a set of log files associated with the common error, the set of log files comprising the first log and the second log. In some embodiments, providing one or more navigational options may be provided at the user interface to incrementally view the subset of log files.

5. Exemplary Devices

Each of the methods described herein may be implemented by a computer system. Each step of these methods may be executed automatically by the computer system, and/or may be provided with inputs/outputs involving a user. For example, a user may provide inputs for each step in a method, and each of these inputs may be in response to a specific output requesting such an input, wherein the output is generated by the computer system. Each input may be received in response to a corresponding requesting output. Furthermore, inputs may be received from a user, from another computer system as a data stream, retrieved from a memory location, retrieved over a network, requested from a web service, and/or the like. Likewise, outputs may be provided to a user, to another computer system as a data stream, saved in a memory location, sent over a network, provided to a web service, and/or the like. In short, each step of the methods described herein may be performed by a computer system, and may involve any number of inputs, outputs, and/or requests to and from the computer system which may or may not involve a user. Those steps not involving a user may be said to be performed automatically by the computer system without human intervention. Therefore, it will be understood in light of this disclosure, that each step of each method described herein may be altered to include an input and output to and from a user or may be done automatically by a computer system without human intervention where any determinations are made by a processor. Furthermore, some embodiments of each of the methods described herein may be implemented as a set of instructions stored on a tangible, non-transitory storage medium to form a tangible software product.

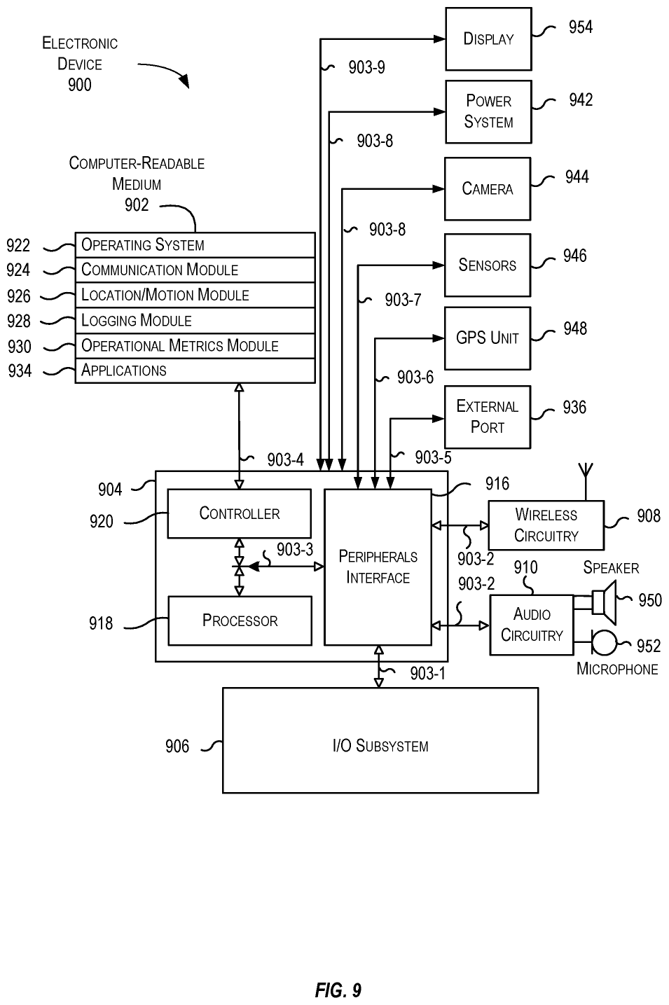

FIG. 9 is a block diagram of an exemplary device 900, which may be an electronic device (e.g., a mobile device) with which the disclosed techniques can performed. Device 900 generally includes computer-readable medium (memory) 902, a processing system 904, an Input/Output (I/O) subsystem 906, wireless circuitry 908, and audio circuitry 910 including speaker 950 and microphone 952. These components may be coupled by one or more communication buses or signal lines 903. Device 900 can be any portable electronic device, including a handheld computer, a tablet computer, a mobile phone, laptop computer, tablet device, media player, a wearable device, personal digital assistant (PDA), a key fob, a car key, an access card, a multifunction device, a mobile phone, a portable gaming device, a car display unit, or the like, including a combination of two or more of these items.

The device 900 can be a multifunction device having a display 954. The display 954 can be a touch screen in accordance with some embodiments. The touch screen optionally displays one or more graphics within user interface (UI). In some embodiments, a user is enabled to select one or more of the graphics by making a gesture on the graphics, for example, with one or more fingers or one or more styluses. In some embodiments, selection of one or more graphics occurs when the user breaks contact with the one or more graphics. In some embodiments, the gesture optionally includes one or more taps, one or more swipes (from left to right, right to left, upward and/or downward) and/or a rolling of a finger (from right to left, left to right, upward and/or downward) that has made contact with device 900. In some implementations or circumstances, inadvertent contact with a graphic does not select the graphic. For example, a swipe gesture that sweeps over an application icon optionally does not select the corresponding application when the gesture corresponding to selection is a tap. Device 900 can optionally also include one or more physical buttons, such as “home” or menu button. As menu button is, optionally, used to navigate to any application in a set of applications that are, optionally executed on the device 900. Alternatively, in some embodiments, the menu button is implemented as a soft key in a graphical user interface displayed on touch screen.

The device 900 can incorporate a display 954. The display 954 can be a liquid crystal display (LCD), organic light emitting diode (OLED), active-matrix organic light emitting diode (AMOLED), Super active-matrix light emitting diode (AMOLED), thin-film transistor (TFT), in-plane switching (IPS), or thin-film transistor liquid crystal display (TFT-LCD) that typically can be found a computing device. The display 954 may be a touch screen display of a computing device.

In one embodiment, device 900 includes touch screen, menu button, push button for powering the device on/off and locking the device, volume adjustment button(s), Subscriber Identity Module (SIM) card slot, head set jack, and docking/charging external port. Push button is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 900 also accepts verbal input for activation or deactivation of some functions through microphone. Device 900 also, optionally, includes one or more contact intensity sensors for detecting intensity of contacts on touch screen and/or one or more tactile output generators for generating tactile outputs for a user of device 900.

In one illustrative configuration, device 900 may include at least one computer-readable medium (memory) 902 and one or more processing units (or processor(s)) 918. Processor(s) 918 may be implemented as appropriate in hardware, software, or combinations thereof. Computer-executable instruction or firmware implementations of processor(s) 918 may include computer-executable instructions written in any suitable programming language to perform the various functions described.

Computer-readable medium (memory) 902 may store program instructions that are loadable and executable on processor(s) 918, as well as data generated during the execution of these programs. Depending on the configuration and type of device 900, memory 902 may be volatile (such as random-access memory (RAM)) and/or non-volatile (such as read-only memory (ROM), flash memory, etc.). Device 900 can have one or more memories. Device 900 may also include additional removable storage and/or non-removable storage including, but not limited to, magnetic storage, optical disks, and/or tape storage. The disk drives and their associated non-transitory computer-readable media may provide non-volatile storage of computer-readable instructions, data structures, program modules, and other data for the devices. In some implementations, memory 902 may include multiple different types of memory, such as static random-access memory (SRAM), dynamic random-access memory (DRAM), or ROM. While the volatile memory described herein may be referred to as RAM, any volatile memory that would not maintain data stored therein once unplugged from a host and/or power would be appropriate.

Memory 902 and additional storage, both removable and non-removable, are all examples of non-transitory computer-readable storage media. For example, non-transitory computer readable storage media may include volatile, or non-volatile, removable or non-removable media implemented in any method or technology for storage of information such as computer-readable instructions, data structures, program modules, or other data. Memory 902 and additional storage are both examples of non-transitory computer storage media. Additional types of computer storage media that may be present in device 900 may include, but are not limited to, phase-change RAM (PRAM), SRAM, DRAM, RAM, ROM, electrically erasable programmable read-only memory (EEPROM), flash memory or other memory technology, compact disc read-only memory (CD-ROM), digital video disc (DVD) or other optical storage, magnetic cassettes, magnetic tape, magnetic disk storage or other magnetic storage devices, or any other medium that can be used to store the desired information and that can be accessed by device 900. Combinations of any of the above should also be included within the scope of non-transitory computer-readable storage media. Based on the disclosure and teachings provided herein, a person of ordinary skill in the art can appreciate other ways and/or methods to implement the various embodiments. However, as noted above, computer-readable storage media does not include transitory media such as carrier waves or the like.

Alternatively, computer-readable communication media may include computer-readable instructions, program modules, or other data transmitted within a data signal, such as a carrier wave, or other transmission. However, as used herein, computer-readable storage media does not include computer-readable communication media.

Device 900 may also contain communications connection(s) enabled by communication module 924 and wireless circuitry 908 that allow device 900 to communicate with a data store, another device or server, user terminals and/or other devices via one or more networks. Such networks may include any one or a combination of many different types of networks, such as cable networks, the Internet, wireless networks, cellular networks, satellite networks, other private and/or public networks, or any combination thereof. Device 900 may also include I/O subsystem 906, that may include I/O devices such as a touch input device, a keyboard, a mouse, a pen, a voice input device, a display, a speaker, a printer, etc.

It should be apparent that the architecture shown in FIG. 9 is only one example of an architecture for device 900, and that device 900 can have more or fewer components than shown, or a different configuration of components. The various components shown in FIG. 9 can be implemented in hardware, software, or a combination of both hardware and software, including one or more signal processing and/or application specific integrated circuits.

Wireless circuitry 908 is used to send and receive information over a wireless link or network to one or more other devices' conventional circuitry such as an antenna system, a radio frequency (RF) transceiver, one or more amplifiers, a tuner, one or more oscillators, a digital signal processor, a codec chipset, memory, etc. Wireless circuitry 908 can use various protocols, e.g., as described herein. For example, wireless circuitry 908 can have one component for one wireless protocol (e.g., Bluetooth®) and a separate component for another wireless protocol (e.g., ultra-wide band ((UWB). Different antennas can be used for the different protocols.

Wireless circuitry 908 is coupled to processing system 904 via peripherals interface 916. Peripherals interface 916 can include conventional components for establishing and maintaining communication between peripherals and processing system 904. Voice and data information received by wireless circuitry 908 (e.g., in speech recognition or voice command applications) is sent to porcessor(s) 918 via peripherals interface 916. Processor(s) 918 are configurable to process various data formats for one or more application programs 934 stored on computer-readable medium (memory) 902.

Peripherals interface 916 couple the input and output peripherals of the device to processor(s) 918 and computer-readable medium 902. Processor(s) 918 communicate with computer-readable medium 902 via a controller 920. Computer-readable medium 902 can be any device or medium that can store code and/or data for use by processor(s) 918. Memory 902 can include a memory hierarchy, including cache, main memory and secondary memory.

Device 900 also includes a power system 942 for powering the various hardware components. Power system 942 can include a power management system, one or more power sources (e.g., battery, alternating current (AC)), a recharging system, a power failure detection circuit, a power converter or inverter, a power status indicator (e.g., a light emitting diode (LED)) and any other components typically associated with the generation, management and distribution of power in mobile devices.

In some embodiments, device 900 includes a camera 944. In some embodiments, device 900 includes sensors 946. Sensors 946 can include accelerometers, compasses, gyrometers, pressure sensors, audio sensors, light sensors, barometers, and the like. Sensors 946 can be used to sense location aspects, such as auditory or light signatures of a location.

In some embodiments, device 900 can include a GPS receiver, sometimes referred to as a GPS unit 948. A mobile device can use a satellite navigation system, such as the Global Positioning System (GPS), to obtain position information, timing information, altitude, or other navigation information. During operation, the GPS unit can receive signals from GPS satellites orbiting the Earth. The GPS unit analyzes the signals to make a transit time and distance estimation. The GPS unit can determine the current position (current location) of the mobile device. Based on these estimations, the mobile device can determine a location fix, altitude, and/or current speed. A location fix can be geographical coordinates such as latitudinal and longitudinal information.

One or more processors 918 run various software components stored in memory 902 to perform various functions for device 900. In some embodiments, the software components include an operating system 922, a communication module 924 (or set of instructions), a location module 926 (or set of instructions), a logging module 928 (or set of instructions), an operational metrics module 930 (or set of instructions), and other applications 934 (or set of instructions).

Operating system 922 can be any suitable operating system, including iOS, Macintosh Operating System (Mac OS), Darwin, Quadros Real-Time Operating System (RTXC), LINUX, UNIX, OS X, Microsoft Windows, or an embedded operating system such as VxWorks. The operating system can include various procedures, sets of instructions, software components and/or drivers for controlling and managing general system tasks (e.g., memory management, storage device control, power management, etc.) and facilitates communication between various hardware and software components. An operating system 922 is system software that manages computer hardware and software resources and provides common services for computer programs. For example, the operating system 922 can manage the interaction between the user interface module and one or more user application(s). The various embodiments further can be implemented in a wide variety of operating environments, which in some cases can include one or more user computers, devices or processing devices which can be used to operate any of a number of applications. User or client devices can include any of a number of general-purpose personal computers, such as desktop or laptop computers running a standard operating system, as well as cellular, wireless and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems and other devices capable of communicating via a network.

Communication module 924 facilitates communication with other devices over one or more external ports 936 or via wireless circuitry 908 and includes various software components for handling data received from wireless circuitry 908 and/or external port 936. External port 936 (e.g., universal serial bus (USB), FireWire, Lightning connector, 60-pin connector, etc.) is adapted for coupling directly to other devices or indirectly over a network (e.g., the Internet, wireless local-area network (LAN), etc.).

Location/motion module 926 can assist in determining the current position (e.g., coordinates or other geographic location identifiers) and motion of device 900. Modern positioning systems include satellite-based positioning systems, such as Global Positioning System (GPS), cellular network positioning based on “cell IDs,” and Wi-Fi positioning technology based on a Wi-Fi networks. GPS also relies on the visibility of multiple satellites to determine a position estimate, which may not be visible (or have weak signals) indoors or in “urban canyons.” In some embodiments, location/motion module 926 receives data from GPS unit 948 and analyzes the signals to determine the current position of the mobile device. In some embodiments, location/motion module 926 can determine a current location using Wi-Fi or cellular location technology. For example, the location of the mobile device can be estimated using knowledge of nearby cell sites and/or Wi-Fi access points with knowledge also of their locations. Information identifying the Wi-Fi or cellular transmitter is received at wireless circuitry 908 and is passed to location/motion module 926. In some embodiments, the location module receives the one or more transmitter IDs. In some embodiments, a sequence of transmitter IDs can be compared with a reference database (e.g., Cell ID database, Wi-Fi reference database) that maps or correlates the transmitter IDs to position coordinates of corresponding transmitters, and computes estimated position coordinates for device 900 based on the position coordinates of the corresponding transmitters. Regardless of the specific location technology used, location/motion module 926 receives information from which a location fix can be derived, interprets that information, and returns location information, such as geographic coordinates, latitude/longitude, or other location fix data.

The electronic device can include a logging module 928. The logging module 928 once activated can receive and store event data that occurs on the electronic device. The event data can include but is not limited to central processing unit (CPU) time, graphics processing unit (GPU) time, memory information, launch time, hang time, average picture luminance (APL), frame rate, logical writes to a solid-state device.

The electronic device can also include an operational metrics module 930. The operational metrics module 930 can receive the event data from the logging module and convert the event data into operational metrics. The metrics can include metadata indicating the operating system 922 version number for the device 900, the class for the device 900 and the model number for the device 900.

The one or more applications programs 934 on the mobile device can include any applications installed on the device 900, including without limitation, a browser, address book, contact list, email, instant messaging, word processing, keyboard emulation, widgets, JAVA-enabled applications, encryption, digital rights management, voice recognition, voice replication, a music player (which plays back recorded music stored in one or more files, such as MP3 or advanced audio coding (AAC) files), etc.

There may be other modules or sets of instructions (not shown), such as a graphics module, a time module, etc. For example, the graphics module can include various conventional software components for rendering, animating and displaying graphical objects (including without limitation text, web pages, icons, digital images, animations and the like) on a display surface. In another example, a timer module can be a software timer. The timer module can also be implemented in hardware. The time module can maintain various timers for any number of events.

The I/O subsystem 906 can be coupled to a display system (not shown), which can be a touch-sensitive display. The display system displays visual output to the user in a GUI. The visual output can include text, graphics, video, and any combination thereof. Some or all of the visual output can correspond to user-interface objects. A display can use LED (light emitting diode), LCD (liquid crystal display) technology, or LPD (light emitting polymer display) technology, although other display technologies can be used in other embodiments.

In some embodiments, I/O subsystem 906 can include a display and user input devices such as a keyboard, mouse, and/or track pad. In some embodiments, I/O subsystem 906 can include a touch-sensitive display. A touch-sensitive display can also accept input from the user based on haptic and/or tactile contact. In some embodiments, a touch-sensitive display forms a touch-sensitive surface that accepts user input. The touch-sensitive display/surface (along with any associated modules and/or sets of instructions in memory 902) detects contact (and any movement or release of the contact) on the touch-sensitive display and converts the detected contact into interaction with user-interface objects, such as one or more soft keys, that are displayed on the touch screen when the contact occurs. In some embodiments, a point of contact between the touch-sensitive display and the user corresponds to one or more digits of the user. The user can make contact with the touch-sensitive display using any suitable object or appendage, such as a stylus, pen, finger, and so forth. A touch-sensitive display surface can detect contact and any movement or release thereof using any suitable touch sensitivity technologies, including capacitive, resistive, infrared, and surface acoustic wave technologies, as well as other proximity sensor arrays or other elements for determining one or more points of contact with the touch-sensitive display.

Further, the I/O subsystem can be coupled to one or more other physical control devices (not shown), such as pushbuttons, keys, switches, rocker buttons, dials, slider switches, sticks, LEDs, etc., for controlling or performing various functions, such as power control, speaker volume control, ring tone loudness, keyboard input, scrolling, hold, menu, screen lock, clearing and ending communications and the like. In some embodiments, in addition to the touch screen, device 900 can include a touchpad (not shown) for activating or deactivating particular functions. In some embodiments, the touchpad is a touch-sensitive area of the device that, unlike the touch screen, does not display visual output. The touchpad can be a touch-sensitive surface that is separate from the touch-sensitive display, or an extension of the touch-sensitive surface formed by the touch-sensitive display.

In some embodiments, some or all of the operations described herein can be performed using an application executing on the user's device. Circuits, logic modules, processors, and/or other components may be configured to perform various operations described herein. Those skilled in the art can appreciate that, depending on implementation, such configuration can be accomplished through design, setup, interconnection, and/or programming of the particular components and that, again depending on implementation, a configured component might or might not be reconfigurable for a different operation. For example, a programmable processor can be configured by providing suitable executable code; a dedicated logic circuit can be configured by suitably connecting logic gates and other circuit elements; and so on.

Most embodiments utilize at least one network that would be familiar to those skilled in the art for supporting communications using any of a variety of commercially-available protocols, such as transmission control protocol/internet protocol (TCP/IP), open systems interconnection model (OSI), file transfer protocol (FTP), universal plug and play (UPnP), network file system (NFS), common internet file system (CIFS), and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a network server, the network server can run any of a variety of server or mid-tier applications, including HyperText Transfer Protocol (HTTP) servers, file transfer protocol (FTP) servers, common gateway interface (CGI) servers, data servers, Java servers, and business application servers. The server(s) also may be capable of executing programs or scripts in response requests from user devices, such as by executing one or more applications that may be implemented as one or more scripts or programs written in any programming language, such as Java®, C, C # or C++, or any scripting language, such as Perl, Python or TCL, as well as combinations thereof. The server(s) may also include database servers, including without limitation those commercially available from Oracle Microsoft®, Sybase®, and IBM®.

Such programs may also be encoded and transmitted using carrier signals adapted for transmission via wired, optical, and/or wireless networks conforming to a variety of protocols, including the Internet. As such, a computer readable medium according to an embodiment of the present disclosure may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (SAN) familiar to those skilled in the art. Similarly, any necessary files for performing the functions attributed to the computers, servers or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen or keypad), and at least one output device (e.g., a display device, printer or speaker). Such a system may also include one or more storage devices, such as disk drives, optical storage devices, and solid-state storage devices such as RAM or ROM, as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a non-transitory computer-readable storage medium, representing remote, local, fixed, and/or removable storage devices as well as storage media for temporarily and/or more permanently containing, storing, transmitting, and retrieving computer-readable information. The system and various devices also typically can include a number of software applications, modules, services or other elements located within at least one working memory device, including an operating system and application programs, such as a client application or browser. It should be appreciated that alternate embodiments may have numerous variations from that described above. For example, customized hardware might also be used and/or particular elements might be implemented in hardware, software (including portable software, such as applets) or both. Further, connection to other devices such as network input/output devices may be employed.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission. A suitable non-transitory computer readable medium can include random access memory (RAM), a read only memory (ROM), a magnetic medium such as a hard-drive or a floppy disk, or an optical medium, such as a compact disk (CD) or DVD (digital versatile disk), flash memory, and the like. The computer readable medium may be any combination of such storage or transmission devices.

Computer programs incorporating various features of the present disclosure may be encoded on various computer readable storage media; suitable media include magnetic disk or tape, optical storage media, such as compact disk (CD) or DVD (digital versatile disk), flash memory, and the like. Computer readable storage media encoded with the program code may be packaged with a compatible device or provided separately from other devices. In addition, program code may be encoded and transmitted via wired optical, and/or wireless networks conforming to a variety of protocols, including the Internet, thereby allowing distribution, e.g., via Internet download. Any such computer readable medium may reside on or within a single computer product (e.g., a solid-state drive, a hard drive, a CD, or an entire computer system), and may be present on or within different computer products within a system or network. A computer system may include a monitor, printer, or other suitable display for providing any of the results mentioned herein to a user.

The specification and drawings are, accordingly, to be regarded in an illustrative rather than a restrictive sense. It will, however, be evident that various modifications and changes may be made thereunto without departing from the broader spirit and scope of the disclosure as set forth in the claims.

As described above, one aspect of the present technology is the gathering and use of data available from various sources to display diagnostics data and at least portions of log files. The present disclosure contemplates that in some instances, this gathered data may include personal information data that uniquely identifies or can be used to contact or locate a specific person. Such personal information data can include demographic data, location-based data, telephone numbers, email addresses, device information, twitter ID's, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used display information regarding operational metrics for third-party application. Accordingly, use of such personal information data can be presented to a user on the display. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of third-party application evaluation techniques, the present technology can be configured to allow users to select to “opt in” or “opt out” of participation in the collection of personal information data during registration for services or anytime thereafter. In another example, users can select not to provide personal information to be displayed. In yet another example, users can select to limit amount of personal data is maintained or entirely prohibit the display of personal data. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the third-party application evaluation techniques, or publicly available information.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the disclosure to the specific form or forms disclosed, but on the contrary, the intention is to cover all modifications, alternative constructions and equivalents falling within the spirit and scope of the disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. The phrase “based on” should be understood to be open-ended, and not limiting in any way, and is intended to be interpreted or otherwise read as “based at least in part on,” where appropriate. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the disclosure and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present. Additionally, conjunctive language such as the phrase “at least one of X, Y, and Z,” unless specifically stated otherwise, should also be understood to mean X, Y, Z, or any combination thereof, including “X, Y, and/or Z.”

Preferred embodiments of this disclosure are described herein, including the best mode known to the inventors for carrying out the disclosure. Variations of those preferred embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

All references, including publications, patent applications, and patents, cited herein are hereby incorporated by reference to the same extent as if each reference were individually and specifically indicated to be incorporated by reference and were set forth in its entirety herein.

What is claimed is:

1. A computer-implemented method, comprising:
obtaining, from one or more electronic devices, diagnostic data comprising a plurality of log files corresponding to a third-party application;
generating a first set of call path signatures comprising at least one call path signature corresponding to a first log file of the plurality of log files, each call path signature of the first set of call path signatures indicating a respective sequence of one or more first function calls of the first log file;
generating a second set of call path signatures comprising at least one call path signature corresponding to a second log file of the plurality of log files, each call path signature of the second set of call path signatures indicating a respective sequence of one or more second function calls of the second log file;
associating the first log file and the second log file with a common error based at least in part on comparing the first set of call path signatures to the second set of call path signatures; and
executing operations causing at least a portion of the diagnostic data corresponding to the common error to be presented at a user interface.

2. The computer-implemented method of claim 1, wherein the portion of the diagnostic data presented at the user interface comprises the first log file.

3. The computer-implemented method of claim 1, wherein the diagnostic data further comprises one or more operational metrics obtained with at least one of the first log file or the second log file.

4. The computer-implemented method of claim 3, wherein the portion of the diagnostic data presented at the user interface comprises at least one of the one or more operational metrics.

5. The computer-implemented method of claim 1, wherein associating the first log file and the second log file with the common error further comprises identifying that the first set of call path signatures and the second set of call path signatures share a threshold number of common sequences.

6. The computer-implemented method of claim 1, wherein the portion of the diagnostic data presented at the user interface comprises a subset of log files selected from a set of log files associated with the common error, the set of log files comprising the first log file and the second log file.

7. The computer-implemented method of claim 6, further comprising providing one or more navigational options to incrementally view the subset of log files.

8. A computing device, comprising:
one or more processors; and
one or more memories storing executable instructions that, when executed by the one or more processors, cause the computing device to:
obtain, from one or more electronic devices, diagnostic data comprising a plurality of log files corresponding to a third-party application;
generate a first set of call path signatures comprising at least one call path signature corresponding to a first log file of the plurality of log files, each call path signature of the first set of call path signatures indicating a respective sequence of one or more first function calls of the first log file;
generate a second set of call path signatures comprising at least one call path signature corresponding to a second log file of the plurality of log files, each call path signature of the second set of call path signatures indicating a respective sequence of one or more second function calls of the second log file;
associate the first log file and the second log file with a common error based at least in part on comparing the first set of call path signatures to the second set of call path signatures; and
execute operations causing at least a portion of the diagnostic data corresponding to the common error to be presented at a user interface.

9. The computing device of claim 8, wherein the portion of the diagnostic data presented at the user interface comprises the first log file.

10. The computing device of claim 8, wherein the diagnostic data further comprises one or more operational metrics obtained with at least one of the first log file or the second log file.

11. The computing device of claim 10, wherein the portion of the diagnostic data presented at the user interface comprises at least one of the one or more operational metrics.

12. The computing device of claim 8, wherein associating the first log file and the second log file with the common error further comprises identifying that the first set of call path signatures and the second set of call path signatures share a threshold number of common sequences.

13. The computing device of claim 8, wherein the portion of the diagnostic data presented at the user interface comprises a subset of log files selected from a set of log files associated with the common error, the set of log files comprising the first log file and the second log file.

14. The computing device of claim 13, wherein executing the executable instructions by the one or more processors further causes the computing device to provide one or more navigational options for incrementally viewing the subset of log files.

15. A computer-readable medium storing executable instructions that, when executed by one or more processors of a computing device, causes the one or more processors to:
obtain, from one or more electronic devices, diagnostic data comprising a plurality of log files corresponding to a third-party application;
generate a first set of call path signatures comprising at least one call path signature corresponding to a first log file of the plurality of log files, each call path signature of the first set of call path signatures indicating a respective sequence of one or more first function calls of the first log file;
generate a second set of call path signatures comprising at least one call path signature corresponding to a second log file of the plurality of log files, each call path signature of the second set of call path signatures indicating a respective sequence of one or more second function calls of the second log file;
associate the first log file and the second log file with a common error based at least in part on comparing the first set of call path signatures to the second set of call path signatures; and
execute operations causing at least a portion of the diagnostic data corresponding to the common error to be presented at a user interface.

16. The computer-readable medium of claim 15, wherein the portion of the diagnostic data presented at the user interface comprises at least one of the first log file or at least one of the one or more operational metrics.

17. The computer-readable medium of claim 15, wherein the diagnostic data further comprises one or more operational metrics obtained with at least one of the first log file or the second log file.

18. The computer-readable medium of claim 15, wherein associating the first log file and the second log file with the common error further comprises identifying that the first set of call path signatures and the second set of call path signatures share a threshold number of common sequences.

19. The computer-readable medium of claim 15, wherein the portion of the diagnostic data presented at the user interface comprises a subset of log files selected from a set of log files associated with the common error, the set of log files comprising the first log file and the second log file.

20. The computer-readable medium of claim 19, wherein executing the executable instructions by the one or more processors of the computing device, causes the one or more processors to provide one or more navigational options for incrementally viewing the subset of log files.
